(19) United States
(12) Patent Application Publication
(10) Pub. No.: US 2023/0368088 A1
(43) Pub. Date: Nov. 16, 2023

(54) SYSTEMS AND METHODS FOR SPECIFYING GOALS AND BEHAVIORAL PARAMETERS FOR PLANNING SYSTEMS OF AUTONOMOUS VEHICLES

(71) Applicant: GM CRUISE HOLDINGS LLC, SAN FRANCISCO, CA (US)

(72) Inventors: Eric Michael Lujan, San Francisco, CA (US); Andrew Robinson, San Francisco, CA (US); Shad Laws, Redwood City, CA (US); Brandon Basso, Oakland, CA (US); William Anthony Silva, San Rafael, CA (US); Lucio Otavio Marchioro Rech, San Mateo, CA (US); Arthur L. Gillespie, III, Sunnyvale, CA (US); Jeremy Allan, Menlo Park, CA (US); Juan Fasola, San Francisco, CA (US); Davide Bacchet, Campbell, CA (US); Nenad Uzunovic, San Carlos, CA (US); Adrian Kit Malaran, San Francisco, CA (US)

(73) Assignee: GM CRUISE HOLDINGS LLC, SAN FRANCISCO, CA (US)

(21) Appl. No.: 17/744,159

(22) Filed: May 13, 2022

(51) Int. Cl. G06Q 10/06

(52) U.S. Cl. CPC G06Q 10/06311

(57) ABSTRACT

Disclosed are systems and methods for specifying goals and behavioral parameters for planning systems of autonomous vehicles. In some aspects, a method includes receiving, by a mission manager in an autonomous vehicle (AV), a mission from an input source of the AV, the mission comprising a request for a task that the AV is to fulfill; deconflicting the mission with one or more other missions of the AV to generate a ranked list of missions; selecting a target mission from the ranked list of missions in accordance with priorities corresponding to each mission in the ranked list of missions; generating one or more scenarios based on the target mission, the one or more scenarios comprising encoded representations of local and geometric terms to cause the target mission to be fulfilled by the AV; and dispatching the one or more scenarios to a planner layer of the AV.

### TECHNICAL FIELD

Embodiments described herein generally relate to the field of autonomous vehicles, and more particularly relate to systems and methods for specifying goals and behavioral parameters for planning systems of autonomous vehicles.

### BACKGROUND

Autonomous vehicles, also known as self-driving cars, driverless vehicles, and robotic vehicles, may be vehicles that use multiple sensors to sense the environment and move without human input. Automation technology in the autonomous vehicles may enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating driving safety. The vehicles can be used to pick up passengers and drive the passengers to selected destinations. The vehicles can also be used to pick up packages and/or other goods and deliver the packages and/or goods to selected destinations.

### BRIEF DESCRIPTION OF THE DRAWINGS

FIG. 1 illustrates an autonomous vehicle and remote computing system architecture in accordance with one embodiment.

FIG. 2 illustrates an example autonomous vehicle in accordance with one embodiment.

FIG. 3 illustrates a functional block diagram for operations of a vehicle in accordance with an embodiment herein.

FIG. 4 illustrates an example method for specifying goals and behavioral parameters for planning systems of autonomous vehicles, in accordance with an embodiment herein.

FIG. 5 illustrates an autonomous vehicle implementing a mission layer for specifying goals and behavioral parameters for planning systems of the autonomous vehicle, in accordance with embodiments herein.

FIG. 6A depicts an example core structure of a scenario application programming interface (API) data structure, in accordance with one embodiment.

FIG. 6B depicts an example core structure of a scenario goal data structure, in accordance with one embodiment.

FIG. 6C depicts an example core structure of a scenario trajectory policy data structure, in accordance with one embodiment.

FIG. 6D depicts an example core structure of a scenario evaluation data structure, in accordance with one embodiment.

FIG. 7 illustrates an example method for generating a scenario from a received mission, in accordance with embodiments herein.

FIG. 8 illustrates an autonomous vehicle implementing a planner layer for specifying goals and behavioral parameters for planning systems of the autonomous vehicle, in accordance with embodiments herein.

FIG. 9 illustrates an example method for generating a trajectory solution for a received scenario, in accordance with embodiments herein.

FIG. 10 illustrates a diagram of a vehicle, according to embodiments herein.

### DETAILED DESCRIPTION

Autonomous vehicles (AVs) can be implemented by companies to provide self-driving car services for the public, such as taxi or ride-haling (e.g., ride-sharing) services. An autonomous vehicle can include perception, decision-making, and control systems that interact to generate an appropriate path to reach a goal position without any collisions for the autonomous vehicle. Generating a path for the autonomous vehicle is a non-nominal process, especially in the highly-dynamic environment of on-road driving, due to the effects of dynamic changes in the driving environment as well as the safety, smoothness, and real-time requirements of the autonomous vehicle.

An architecture of the decision-making steps of an autonomous vehicle can be generally divided into four steps: route planning, behavioral analysis, motion planning, and local control. The route planning step can calculate a route based on the vehicle start and destination and road network to show which directions to take. The behavioral analysis step can be performed by perceiving the surrounding environment of the autonomous vehicle and other vehicles involved in the traffic and then choosing an appropriate driving behavior based on such perception. An autonomous vehicle may utilize many sensors and cameras to assess the immediate environment to make a sound perception of the surrounding environment and decide appropriate behavior for the autonomous vehicle. The behavioral analysis step can choose, based on the perception made through the sensors and cameras, an appropriate driving behavior for the autonomous vehicle. For example, the behavioral analysis step may determine that another vehicle is coming to a stop in front of the autonomous vehicle based on the sensors and cameras of the autonomous vehicle, and then correspondingly cause the autonomous vehicle to come to a stop to avoid a collision with the other vehicle. In another example, the behavioral analysis step may determine that an emergency vehicle is approaching the autonomous vehicle based on the sensors and cameras, and then correspondingly cause the autonomous vehicle to pull over in a safe location as needed.

The motion planning step can then calculate a kinematically-feasible path and trajectory to move the vehicle from the start point to the destination in a safe, collision-free, and comfortable way. A trajectory planner (may be referred to as a “planning system” or “planner”) includes temporal information (e.g., speed and acceleration profile), in addition to spatial information, of the autonomous vehicle that determines how the vehicle should travel in the calculated path. The local control step includes implementing control operations to effectuate operation of the mechanical systems of the autonomous vehicle in accordance with the calculated path and trajectory.

In some autonomous vehicle systems, an external interface to the trajectory planner is fragmented and does not readily express key attributes that may be necessary to support some use cases under a unified application programming interface (API). For example, some of the use cases can include freespace planning, parking lot navigation, full out-of-lane pullovers, supplying more than one acceptable goal, making urgent stops from upstream systems, and so on. Within the autonomous vehicle systems, different upstream systems from the trajectory planner each have their own concerns for affecting behavior of the autonomous vehicle via the trajectory planner, as well as their own implementations and management of how to cause the autonomous vehicle (via the trajectory planner) to implement the desired behavior(s). Moreover, these upstream systems should carefully orchestrate with one another to ensure that the upstream systems do not conflict, while each simultaneously having direct-level access to the behavioral parameters of the trajectory planner that control the behavior of the autonomous vehicle. This above-described “vertical” solution of these autonomous vehicle systems results in bounding and stitching together of multiple layers/stages, which can lead to conflicts that negatively affect performance of the autonomous vehicle systems, as well as a complicated architecture requiring frequent updates.

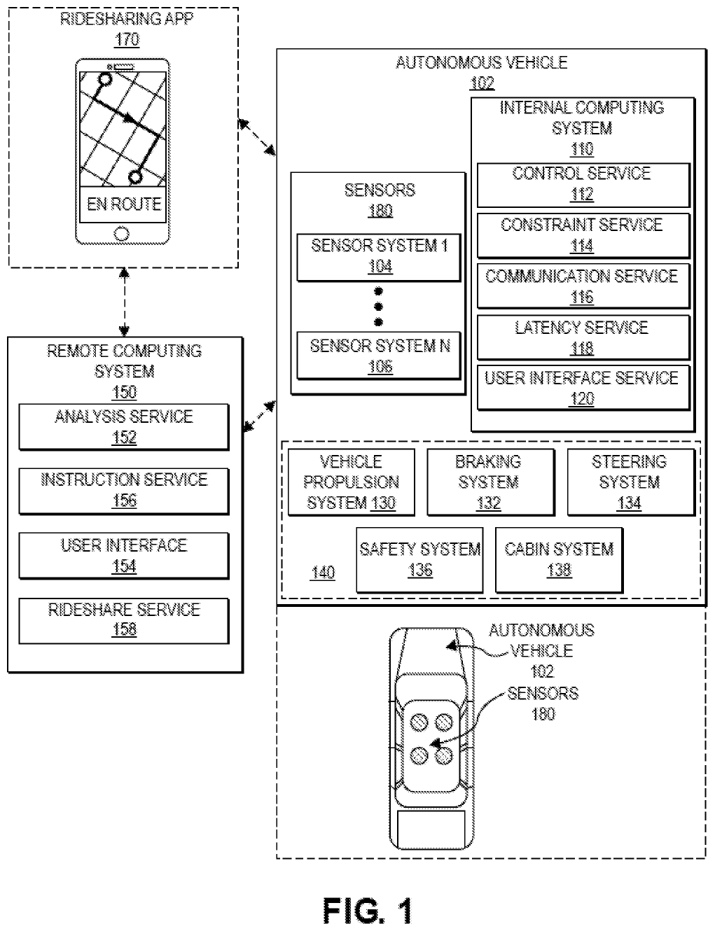

To address the above-noted problems, vehicle systems, apparatuses, and methods for specifying goals and behavioral parameters for planning systems of autonomous vehicles are described. In one example embodiment, a mission manager of an autonomous vehicle can receive a mission from an input source of the autonomous vehicle. The mission may refer to a request, using abstract terms, for a task that the autonomous vehicle is to fulfill. The mission can be deconflicted with one or more other missions of the autonomous vehicle to generate a ranked list of missions. Then, a target mission is selected from the ranked list of missions in accordance with priorities corresponding to each mission in the ranked list of missions. In one embodiment, one or more scenarios are generated from the target mission. The one or more scenarios can include encoded representations of local and geometric terms to cause the target mission to be fulfilled by the autonomous vehicle. The one or more scenarios are then dispatched to a planner layer of the autonomous vehicle. Further details of the systems, apparatuses, and methods for specifying goals and behavioral parameters for planning systems of autonomous vehicles are provided below with respect to FIGS. 1-10.

Embodiments herein provide for an enablement of separation of concerns within the systems of an autonomous vehicle. By providing separate application programming interfaces (APIs) for missions and scenarios as input to a planning layer of the autonomous vehicle, embodiments herein are able to abstract the sematic scene-level concerns detailed in a mission and/or scenario from the primary concerns of the planning layer (e.g., to generate safe and comfortable trajectories). As a result, the primary concerns of the planning layer can be kept independent from and resolved separately from the mission and scenario-specific concerns of the upstream non-planning layer components of the autonomous vehicle. Furthermore, abstracting the scene-level concerns from the lower-level planning layer concerns via the missions and scenarios provided by embodiments herein allows for implementation of multiple different planner architectures in an autonomous vehicle that can each process and resolve the same scenarios. This multiple planner architecture can be supported without having to update the structure and format of the mission and/or the scenario based on the particular planner implementation. This results in improved planner implementations and results in improved planner processing and bandwidth efficiency in the autonomous vehicle.

In the following description, for purposes of explanation, numerous specific details are set forth in order to provide a thorough understanding of the embodiments herein. It will be apparent, however, to one skilled in the art that the embodiments herein can be practiced without these specific details. In other instances, well-known structures and devices are shown in block diagram form in order to avoid obscuring the embodiments herein.

Reference in the specification to “one embodiment” or “an embodiment” means that a particular feature, structure or characteristic described in connection with the embodiment is included in at least one embodiment herein. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The following glossary of terminology and acronyms serves to assist the reader by providing a simplified quick-reference definition. A person of ordinary skill in the art may understand the terms as used herein according to general usage and definitions that appear in widely available standards and reference books.

FIG. 1 illustrates an autonomous vehicle and remote computing system architecture in accordance with one embodiment. The autonomous vehicle 102 can navigate about roadways without a human driver based upon sensor signals output by sensor systems 180 of the autonomous vehicle 102. The autonomous vehicle 102 includes a plurality of sensor systems 180 (e.g., a first sensor system 104 through an Nth sensor system 106). The sensor systems 180 are of different types and are arranged about the autonomous vehicle 102. For example, the first sensor system 104 may be a camera sensor system and the Nth sensor system 106 may be a Light Detection and Ranging (LIDAR) sensor system to perform ranging measurements for localization. Other example sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it should be understood that more or fewer sensors may be coupled to the autonomous vehicle 102.

Although variously described herein as an autonomous vehicle or another device collecting data of surrounding vehicles, this data may be collected without associated identifiable information from these surrounding vehicles (e.g., without license plate numbers, make, model, and color of the vehicles). Accordingly, the techniques mentioned herein can be used for the beneficial purposes described throughout but without the need to store potentially sensitive information of surrounding vehicles.

The autonomous vehicle 102 further includes several mechanical systems that are used to effectuate appropriate motion of the autonomous vehicle 102. For instance, the mechanical systems can include but are not limited to, a vehicle propulsion system 130, a braking system 132, and a steering system 134. The vehicle propulsion system 130 may include an electric motor, an internal combustion engine, or both. The braking system 132 can include an engine brake, brake pads, actuators, and/or any other suitable componentry that is configured to assist in decelerating the autonomous vehicle 102. In some cases, the braking system 132 may charge a battery of the vehicle through regenerative braking. The steering system 134 includes suitable componentry that is configured to control the direction of movement of the autonomous vehicle 102 during navigation.

The autonomous vehicle 102 further includes a safety system 136 that can include various lights and signal indicators, parking brake, airbags, etc. The autonomous vehicle 102 further includes a cabin system 138 that can include cabin temperature control systems, in-cabin entertainment systems, etc.

The autonomous vehicle 102 additionally comprises an internal computing system 110 that is in communication with the sensor systems 180 and the systems 130, 132, 134, 136, and 138. The internal computing system 110 includes at least one processor and at least one memory having computer-executable instructions that are executed by the processor. The computer-executable instructions can make up one or more services responsible for controlling the autonomous vehicle 102, communicating with remote computing system 150, receiving inputs from passengers or human co-pilots, logging metrics regarding data collected by sensor systems 180 and human co-pilots, etc. In one embodiment, the internal computing system 110 implements the systems and methods for specifying goals and behavioral parameters for planning systems of autonomous vehicles described herein.

The internal computing system 110 can include a control service 112 that is configured to control operation of a mechanical system 140, which includes vehicle propulsion system 130, the braking system 132, the steering system 134, the safety system 136, and the cabin system 138. The control service 112 receives sensor signals from the sensor systems 180 and communicates with other services of the internal computing system 110 to effectuate operation of the autonomous vehicle 102. In some embodiments, control service 112 may carry out operations in concert with one or more other systems of autonomous vehicle 102. The control service 112 can control driving operations of the autonomous vehicle 102 based on sensor signals from the sensor systems 180. In one example, the control service receives sensor signals to monitor driving operations and to determine localization of the vehicle. The control service determines lateral force disturbances for front and rear lateral accelerations and a bulk longitudinal force disturbance for the vehicle based on the localization and the sensor signals. The control service determines a tire road limit nearness estimation for the vehicle based on the sensor signals, the lateral force disturbances for front and rear lateral accelerations and a bulk longitudinal force disturbance.

The internal computing system 110 can also include a constraint service 114 to facilitate safe propulsion of the autonomous vehicle 102. The constraint service 116 includes instructions for activating a constraint based on a rule-based restriction upon operation of the autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 112.

The internal computing system 110 can also include a communication service 116. The communication service can include both software and hardware elements for transmitting and receiving signals from/to the remote computing system 150. The communication service 116 is configured to transmit information wirelessly over a network, for example, through an antenna array that provides personal cellular (long-term evolution (LTE), 3G, 4G, 5G, etc.) communication.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions, etc.

The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, the latency service 118 can enable other systems of autonomous vehicle 102 or a passenger to make decisions or to provide the feedback.

The internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 102 regarding reporting data for training and evaluating machine learning algorithms, requesting assistance from remote computing system 150 or a human operator via the remote computing system 150, software service updates, rideshare pickup and drop off instructions, etc.

The remote computing system 150 includes an analysis service 152 that is configured to receive data from autonomous vehicle 102 and analyze the data to train or evaluate machine learning algorithms for operating the autonomous vehicle 102 such as performing object detection for methods and systems disclosed herein. The analysis service 152 can also perform analysis pertaining to data associated with one or more errors or constraints reported by autonomous vehicle 102. In another example, the analysis service 152 is located within the internal computing system 110.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

The remote computing system 150 can also include a rideshare service 158 configured to interact with ridesharing applications 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc.

The rideshare service 158 as depicted in FIG. 1 illustrates a vehicle 102 as a triangle enroute from a start point of a trip to an end point of a trip, both of which are illustrated as circular endpoints of a thick line representing a route traveled by the vehicle. The route may be the path of the vehicle from picking up the passenger to dropping off the passenger (or another passenger in the vehicle), or it may be the path of the vehicle from its current location to picking up another passenger.

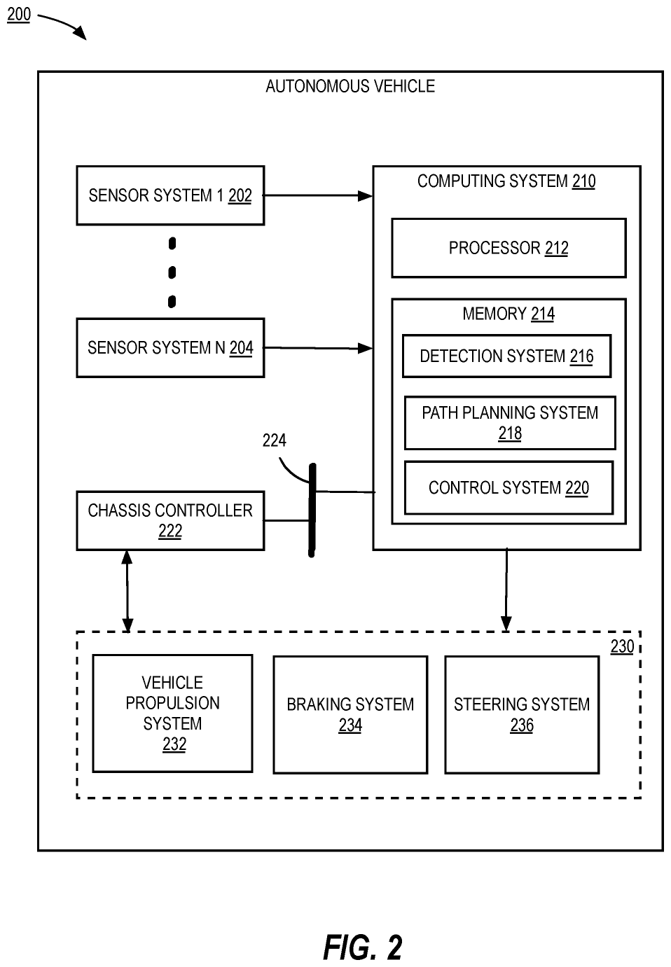

FIG. 2 illustrates an example autonomous vehicle 200 in accordance with one embodiment. In one embodiment, autonomous vehicle 200 is the same as autonomous vehicle 102 described with respect to FIG. 1. The autonomous vehicle 200 can navigate about roadways without a human driver based upon sensor signals output by sensor systems 202-204 of the autonomous vehicle 200. The autonomous vehicle 200 includes a plurality of sensor systems 202-204 (a first sensor system 202 through an Nth sensor system 204). The sensor systems 202-204 are of different types and are arranged about the autonomous vehicle 200. For example, the first sensor system 202 may be a camera sensor system and the Nth sensor system 204 may be a lidar sensor system. Other example sensor systems include, but are not limited to, radar sensor systems, global positioning system (GPS) sensor systems, inertial measurement units (IMU), infrared sensor systems, laser sensor systems, sonar sensor systems, and the like. Furthermore, some or all of the of sensor systems 202-204 may be articulating sensors that can be oriented/rotated such that a field of view of the articulating sensors is directed towards different regions surrounding the autonomous vehicle 200.

The autonomous vehicle 200 further includes several mechanical systems that can be used to effectuate appropriate motion of the autonomous vehicle 200. For instance, the mechanical systems 230 can include but are not limited to, a vehicle propulsion system 232, a braking system 234, and a steering system 236. The vehicle propulsion system 232 may include an electric motor, an internal combustion engine, or both. The braking system 234 can include an engine break, brake pads, actuators, and/or any other suitable componentry that is configured to assist in decelerating the autonomous vehicle 200. The steering system 236 includes suitable componentry that is configured to control the direction of movement of the autonomous vehicle 200 during propulsion.

The autonomous vehicle 200 additionally includes a chassis controller 222 that is activated to manipulate the mechanical systems 230 when an activation threshold of the chassis controller 222 is reached.

The autonomous vehicle 200 further comprises a computing system 210 that is in communication with the sensor systems 202-204, the mechanical systems 230, and the chassis controller 222. While the chassis controller 222 is activated independently from operations of the computing system 210, the chassis controller 222 may be configured to communicate with the computing system 210, for example, via a controller area network (CAN) bus 224. The computing system 210 includes a processor 212 and memory 214 that stores instructions which are executed by the processor 212 to cause the processor 212 to perform acts in accordance with the instructions.

The memory 214 comprises a detection system 216, a path planning system 218, and a control system 220. The detection system 216 identifies objects in the vicinity (e.g., scene context) of the autonomous vehicle 200. The detection system 216 may analyze sensor signals generated by the sensor system 202-204 to identify the objects. Detection system 216 may also identify characteristics of the detected objects, such as distance, velocity, direction, and so on. In some embodiments, the detection system 216 implements one or more trained machine learning (ML) models for the object identification.

The path planning system 218 generates a path plan for the autonomous vehicle 200, wherein the path plan can be identified both spatially and temporally according to one or more impending timesteps. The path plan can include one or more maneuvers to be performed by the autonomous vehicle 200. In one embodiment, the path planning system 218 can respond to scenarios specifying goals and behavioral parameters for planning systems of autonomous vehicles, in accordance with the techniques discussed herein.

The control system 220 is configured to control the mechanical systems of the autonomous vehicle 200 (e.g., the vehicle propulsion system 232, the braking system 234, and the steering system 236 based upon an output from the sensor systems 202-204 and/or the path planning system 218. For instance, the mechanical systems can be controlled by the control system 220 to execute the path plan determined by the path planning system 218. Additionally, or alternatively, the control system 220 may control the mechanical systems 206-210 to navigate the autonomous vehicle 200 in accordance with outputs received from the sensor systems 202-204.

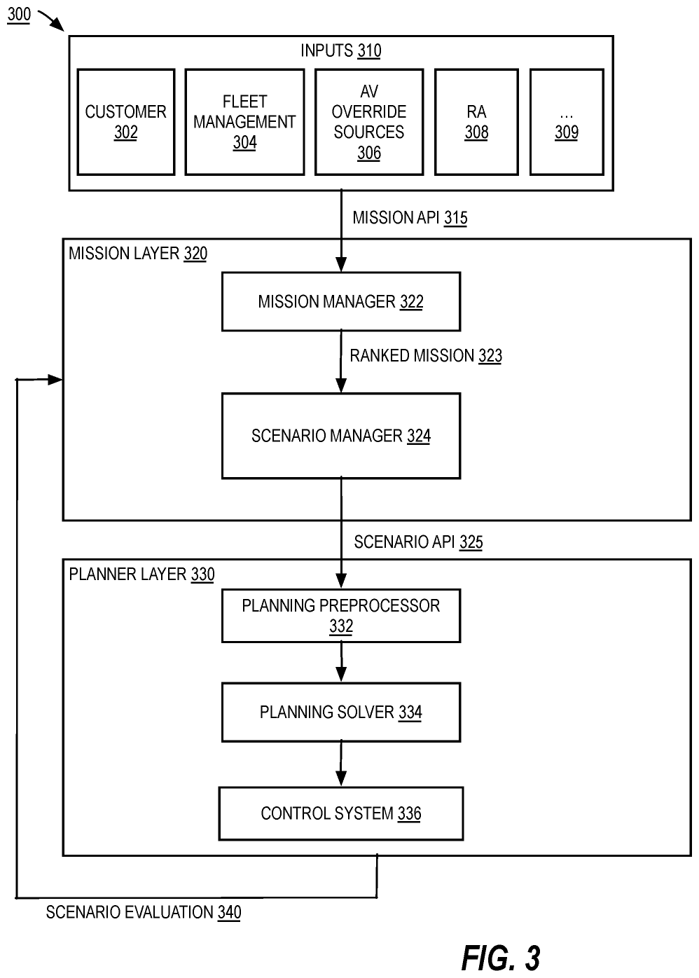

FIG. 3 illustrates a functional block diagram for operations of a vehicle 300 (e.g., an autonomous vehicle (AV), which in some embodiments is fully autonomous while in other embodiments is a driver-assisted vehicle, etc.) in accordance with an embodiment herein. The vehicle 300 includes input sources 310, a mission layer 320, and a planner/planning layer 330. The input sources 310 can include a customer/rider 302 to send an input address to the mission layer 320, a fleet management source 304 to send an instruction (e.g., return to base station and charge the AV) to the mission layer 320, AV override sources 306 (e.g., map change detector to detect map changes, emergency vehicle detector to detect emergency vehicles, end trip detector to detect or receive an end trip request, collision detector to detect collisions, unsupported conditions detector to detect unsupported conditions, etc.) to send override requests to the mission layer 320, remote assistance 308 to send a request to the mission layer 320, and other sources 309.

The mission API 315 provides a single API between input sources 310 and the mission layer 320. An API may refer to a connection/interface between computer programs or components of computer programs. An API is a type of software interface, offering a service to other pieces of software. A document or standard that describes how to build or use such a connection or interface is called an API specification. A computing system that meets this standard is said to “implement” or “expose” an API. In some cases, the term API may refer either to the specification or to the implementation. At the mission layer 320 level, the request of the mission API 315 (such request may be referred to herein as missions) can be high level and express an intent of the request, without explicit knowledge of the specific implementation details. In some embodiments, each input source 310 can request one or more missions using the same, unified mission API 315.

In one embodiment, missions express an intent at a semantic level (i.e., “Drive to A”, “Stop”). The amount of information contained in a mission can be minimal or even incomplete (e.g., a “pullover” mission that does not specify pullover location). In embodiments herein, the responsibility of the mission layer 320 is to collect the missions from the different input sources 310 and deconflict them using a current state and context of the vehicle 300.

Context and additional constraints can be sent independently from the mission with the rationale being that some input sources 310 may not have enough context to communicate the best possible intent of the mission. In one example, a map change detector may not need to be aware of which mission is active. Instead, the mission layer 320 may have a more complete understanding of the context, and can decide the best action (e.g., reduce speed if the map change is non-critical, or switch to a “Stop” mission in case the map change is critical).

In embodiments herein, more than one mission can be sent from the different input sources 310 using the mission API 31. The mission manager 322 can collect the missions received from the different input sources 310 and deconflict them using a current state and context of the vehicle 300. The mission manager 322 can then select a mission to execute based on the de-confliction. The selected mission (ranked mission 232) is then provided to the scenario manager 324 of the mission layer 320 to be translated into one or more planner scenarios (referred to herein as a scenario). A scenario encodes the intent of the mission within an interface suitable for the planner layer 330 to generate and evaluate candidate trajectory solutions.

In one embodiment, at the scenario manager 324, the mission 323 can be translated into a geometric and quantitative description of the sequence of actions that are requested to the planner layer 330. This geometric and quantitative description of the sequence of actions is referred to as a scenario. A single scenario may be generated to fulfill a mission, or a set of scenarios may be generated to fulfill the mission (where each scenario of the set partially fulfills the mission). In one embodiment, the generated scenario(s) are passed to the planner layer 330 using a common and unified scenario API 325, which is abstracted in a way that allows for multiple types of planners to implement and execute according to the planner's specific capabilities.

In embodiments herein, scenarios are tactical and mapped to the underlying autonomous vehicle capabilities, and the scenario API 325 reflects that. A scenario may contain constraints on an end state of the scenario, reference waypoints, and additional information such as urgency, etc. Providing the end state and corresponding constraints in a scenario allows the mission manager 322 to specify detailed stopping scenarios. The scenario manager 324 handles normal driving, consolidating the high-level decisions communicated by the mission manager 322 and the current driving and environment context into a continuously updated scenario that is then communicated to the planner layer 330 using the scenario API 325. In some embodiments, the scenario manager 324 can utilize a routing engine to lead the vehicle towards a global goal by defining intermediate goals that correspond to goals in the local horizon that make progress towards the final destination.

The scenario manager 324 packages these goals in the local horizon with global route costs to give the downstream planner enough context to make decisions around importance and trade-offs with global trip cost. In some embodiments, the scenario manager 324 can process goal and scenario override interrupts (e.g., map change detection, immediate pullover button selection, cabin tampering, remote assistance, etc.). When a global goal is nearby, the scenario manager 324 directly sends this goal to the downstream planner layer 330. In some embodiments, scenarios are created in the mission layer 320, and sent to the planner layer 330 as an ordered list of scenarios.

The planner layer 330 includes a planning preprocessor 332, a planning solver 334, and control system 336. The planning preprocessor [symbol] condenses driving concerns into a format that the planning solver 334 can operate on and any intermediate scene preprocessing, as needed. As the planning solver 334 operates more generally on broader concepts (such as obstacles, buffers, areas to keep clear of, spatial cost zones, etc.), the planning preprocessor 332 builds representational inputs given the current route and/or scene context (i.e., approaching a traffic light intersection, if it is the autonomous vehicle's turn at an all-way stop, etc.) of the autonomous vehicle. In some embodiments, some or most of the logic in the planning preprocessor 332 can be transferred to the planning solver 334.

The planning solver 334 can accept a proposed and prioritized set of scenarios or goals from the scenario manager 324, solve the scenarios or goals leveraging the priority (e.g., generate trajectory candidates that satisfy the parameters and constraints of the scenario(s)/goal(s) using sampling methods, graph methods, gradient search methods, candidate iteration and evaluation methods, ML-derived trajectory generation, etc.), execute the best candidate scenario, report information about the solutions to the mission layer 320, and produce trajectory plans for the control system 336. The control system 336 can generate and send vehicle command signals to the mechanical systems of the vehicle 300 based on the trajectory plans. With respect to the planning solver 334 solving the scenarios or goals by leveraging the priority, some examples of this include, but are not limited to, determining the best location to pullover and drop off a passenger given a ranked list of candidate pullover scenarios in order of priority, deciding to miss a left turn for the passenger's route in order to fulfill the higher priority scenario for pulling over for an EMV, and so on.

In embodiments herein, there can be more than one planner (e.g., nominal and fallback stacks) implemented in the planner layer 330, and each planner can internally use several different algorithms and solvers. Utilization of the common mission API 315 and scenario API 325 described herein by the different planners allows for abstraction of the behavioral parameters implemented by the planners from the upstream systems providing input via the mission layer 320.

After the planner layer 330 finishes solving, the planner layer 330 can share whether a scenario was satisfied as a scenario evaluation 340. The mission manager 322 can utilize the information from the scenario evaluation 340 to track progress towards scenario completion and manage a current portfolio of active scenarios. The scenario evaluation 340 is communicated back to the mission layer 320, which can then propagate it back to the customer (e.g., a remote operator that is using the remote computing system 150 to assist operation of the vehicle 300) or reuse it to re-prioritize subsequent scenarios. The planner layer 330 does not have to wait for the mission manager 322 to select the best scenario to be executed, and may report the relevant information at every clock tick. That information contains, among others, which scenarios have been explored, success/failure flags, the active scenario, and its progress, for example.

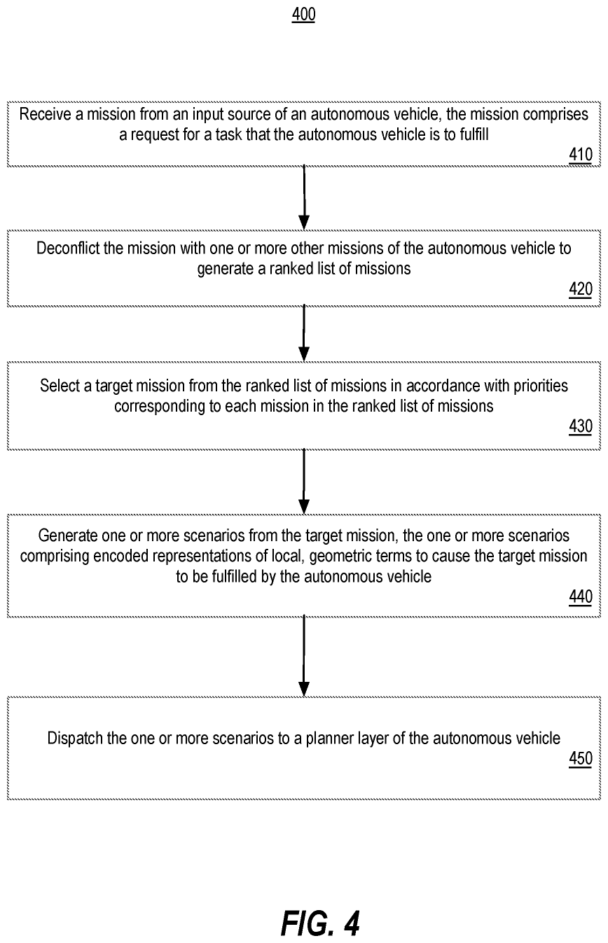

FIG. 4 illustrates an example method 400 for specifying goals and behavioral parameters for planning systems of autonomous vehicles. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some embodiments, the method 400 includes block 410 where a mission manager in an autonomous vehicle receives a mission from an input source of the AV. In one embodiment, the mission includes a request for a task that the autonomous vehicle is to fulfill. The mission may be implemented and communicated using a mission API of the autonomous vehicle. In some embodiments, the request of the mission may be communicated in abstract terms. Abstract terms may refer to any variety of formatting options, such as natural language terminology in a text format, a general-purpose high level language format, a specific messaging format, and so on. For example, the request of the mission may be communicated as “drop off at 123 Main St.”, “park in any open parking stall in the XYZ lot”, “stop for the emergency vehicle”, and so on. The mission API allows for flexibility in how the mission requests can be communicated between processes of the autonomous vehicle.

At block 420, the mission is deconflicted with one or more other missions of the autonomous vehicle to generate a ranked list of missions. Deconflicting may refer to narrowing down the set of all candidate missions to a smaller, ranked set, with contradicting missions either pruned or strictly prioritized with respect to one another. In one embodiment, the ranked list of missions may be ranked in accordance with a priority attribute corresponding to each mission. For example, a mission having a highest priority value may be ranked first in the ranked list of missions. In some embodiments, the missions can be ranked in accordance with a set of rules and/or requirements maintained by the mission manager.

Subsequently, at block 430, a target mission is selected from the ranked list of missions. In one embodiment, the target mission is selected in accordance with priorities corresponding to each mission in the ranked list of missions. For example, the target mission may be the highest priority mission in the ranked list of missions. In one embodiment, the priorities may be assigned to the missions by the mission manager.

Then, at block 440, one or more scenarios are generated from the target mission. In one embodiment, the one or more scenarios include encoded representations of local and geometric terms that can cause the target mission to be fulfilled by the autonomous vehicle. In one embodiment, the scenarios are generated using a messaging format that is conducive to inter-process communication. Some examples of such messaging formats and/or communication mediums may include, but are not limited to, a robot operating system (ROS) message format, Microsoft Robotics Developer Studio (MRDS), CARMEN, Mobile Robot Programming Toolkit, LCM (Lightweight Communications and Marshalling), messaging queues, shared memory, memory-mapped files, networking communications, remote procedure calls (RPC and/or gRPC), and so on. The scenarios can include one or more parameters including, but not limited to, an identifier, a priority, a goal, and a trajectory policy. In one embodiment, the goal can include parameters such as an end state for the autonomous vehicle and constraints that may apply to that end state. The trajectory policy can include parameters such as an urgency and behavioral flags.

Lastly, at block 450, the one or more scenarios are dispatched to a planner layer of the autonomous vehicle. In one embodiment, the planner layer can accept a proposed and prioritized set of scenarios, solve the scenarios leveraging the priority, execute the best candidate scenario, report information about the solutions to the mission manager, and produce trajectory plans for a control system of the autonomous vehicle, which can generate and send vehicle command signals to mechanical systems of the autonomous vehicle based on the trajectory plans.

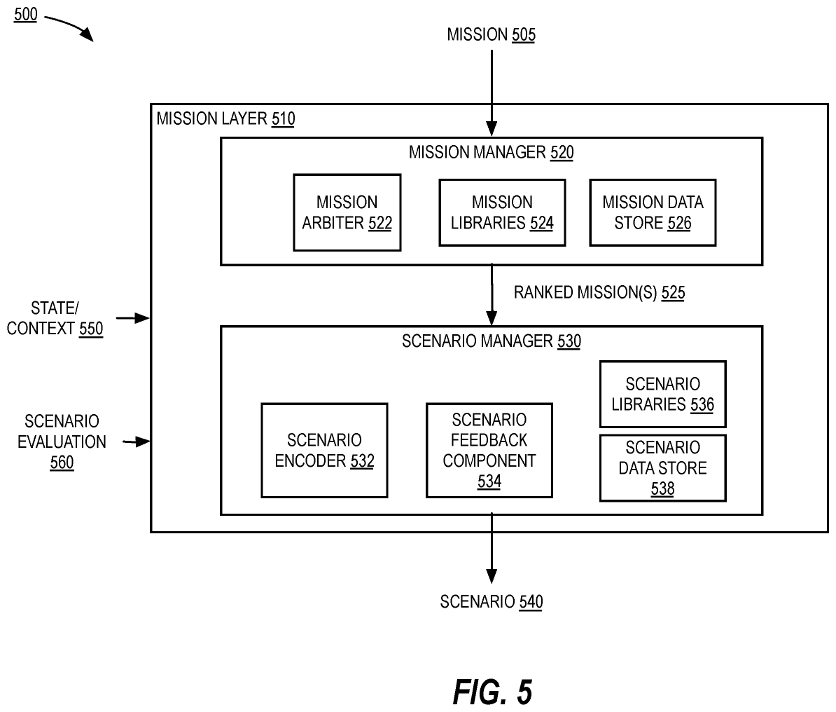

FIG. 5 illustrates an autonomous vehicle 500 implementing a mission layer 510 for specifying goals and behavioral parameters for planning systems of the autonomous vehicle, in accordance with embodiment herein. In one embodiment, the mission layer 510 is the same as mission layer 320 described with respect to FIG. 3. As illustrated, in one embodiment, the mission layer 510 may include a mission manager 520 and a scenario manager 530. In embodiments herein, the mission manager 520 and the scenario manager 530, as well as their sub-components, may be implemented by hardware, software, firmware and/or any combination of hardware, software and/or firmware of a computing system.

In embodiments herein, the mission layer 510 receives one or more missions 505 at the mission manager 520, which are translated into one or more scenarios 540 by the scenario manager 530. As previously discussed, the missions 505 can encompass a request, in abstract terms, for the autonomous vehicle to accomplish a task. In some embodiments, the mission can leave a large degree of freedom in terms of how the task can be accomplished. The request of a mission can be high-level and express the intent of the task, without explicit knowledge of the specific implementation details to effectuate the task. The mission can be specified as a far-away location, although a mission can also specify a goal in a local planning horizon. Some examples of missions can include “Drive to A”, “Stop”, “Drop off at 123 Main St.”, “Drop off near 123 Main St.”, “Drop off anywhere on the 100 Main St. block; avoid red curbs”, “Loiter around the block”, “Park in any open parking stall in the DELTA lot”, “Stop for emergency vehicle”, “Follow RA path”, to name a few examples. In some cases, the amount of information contained in a mission may be minimal or even incomplete.

In embodiments herein, the mission may be generated and communicated in accordance with a single, unified mission API implemented at the autonomous vehicle. The mission API specifies an interface between input sources (such as inputs 310 of FIG. 3) and the mission layer 510 to communicate missions.

The mission manager 520 is responsible for collecting the missions 505 from different input sources (internal and/or external to the autonomous vehicle) and deconflicting the collected missions 505. The mission manager 520 may include a mission arbiter 522 to analyze and deconflict missions 505. In one embodiment, deconflicting a mission 505 may refer to comparing an incoming mission 505 to other pending missions of the autonomous vehicle to determine a mission priority amongst the missions and rank the missions in accordance with the mission priority.

In one embodiment, the mission manager 520 may use one or more of an intent of the mission 505, a source (e.g., input source) of the mission 505, and/or a current state and context 550 of the autonomous vehicle 500 to determine the mission priorities and deconflict the mission 505. In some embodiments, the intent of the mission 505 may be categorized into one of stop, go to destination, pullover, or park. The mission arbiter 522 can discern the intent of the mission 505 from the language of the mission 505 itself. For example, a “Stop for emergency vehicle” mission can be categorized as having a stop intent.

In one example, a mission of “Stop for emergency vehicle” may garner a high mission priority level (e.g., the highest mission priority level) and may thus rank higher than an active (e.g., in-progress) mission of “Drive to A” that may currently be pending at the autonomous vehicle. If, in the example, there are three possible mission priority levels of 0, 1, and 2 (with 0 being the highest mission priority level and 2 being the lowest mission priority level), the “Stop for emergency vehicle” mission may be assigned a mission priority level of 0, while the “Drive to A” is assigned a mission priority level of 2. The mission arbiter 522 may include logic to analyze the source (e.g., input source) of the mission and a type (e.g., intent) of the mission (e.g., stop, go to destination, pullover, park) and may assign a mission priority level based on those factors. The mission arbiter 522 can also access one or more of mission libraries 524 and/or mission data store 526 to reference determined resources that can categorize a mission with a determined mission priority level based on the mission intent, the source of the mission, and/or the current state and context of the autonomous vehicle. In some embodiments, the mission 505 may include a pre-assigned priority level that is provided by the input source of the mission.

State/context 550 and additional constraints can be sent to the mission layer 510 independently from the mission 505 with the rationale being that some input sources may not have enough context to communicate the best possible intent of the mission. In one example, a map change detector may not need to be aware of which mission is active. The mission layer 510 may have a more complete understanding of the context 550, and can decide the best action (e.g., reduce speed if the map change is non-critical, or switch to a “Stop” mission in case the change is critical).

The mission manager 520 can select a target mission to fulfill (from the set of received missions) based on the de-confliction performed by the mission arbiter 522. The selected target mission (ranked mission 525) is then provided to the scenario manager 530 of the mission layer 510 to be translated into one or more scenarios 540. In some embodiments, the entire list of ranked missions 525 can be provided to the scenario manager 530.

The scenario manager 530 generates one or more scenarios 540 to fulfill the ranked mission 525. A scenario 540 encodes the intent of the mission within an interface suitable for lower-level planner systems (e.g., planner layer 330 of FIG. 3) of the autonomous vehicle to generate and evaluate candidate solutions. In some embodiments, the scenario 540 is a generic representation of an autonomous vehicle response in a ROS message format. The generic representation encoded in a scenario 540 is an expression of autonomous vehicle response intent, rather than a specific trajectory or directives for the autonomous vehicle to follow.

A scenario encoder 532 of the scenario manager 530 may be responsible for analyzing a received ranked mission 525 (referred to herein as mission 525) and encoding the mission 525 into one or more scenarios 540 that fulfill (at least partially) the mission 525. The scenario encoder 532 specifies the scenario 540 in local and/or geometric terms and incorporates the state and context 550 information (e.g., local scene information (such as parked vehicles emergency vehicles, etc.) and global router lane graph information) into the scenario 540. The scenario encoder 532 may also incorporate knowledge of downstream planner capabilities in order to generate the scenario(s) 540.

In one embodiment, the scenario 540 may include parameters (e.g., components, terms, parts) of behaviors of the autonomous vehicle to meet a goal state indicated by the scenario 540. The parameters may include, for example, an identifier, a priority, one or more goals, and/or a trajectory policy. In one embodiment, the goal can include parameters such as an end state for the autonomous vehicle and constraints that may apply to that end state. The trajectory policy can include parameters such as an urgency and behavioral flags. The priority may indicate an overriding priority to utilize for ranking the scenario 540 against other scenarios received at the lower-level planning systems. The goals may outline constraints on the end state of the scenario such as, for example, whether the autonomous vehicle should stop, inclusion and exclusion regions for the end state, whether to use hazards, and/or other behaviors to implement after coming to a stop (e.g., shift to park, apply emergency brake, etc.). The trajectory policy may provide additional details on how the planner layer should cost trajectories for the scenario, and can include parameters such as urgency and behavioral flags. The urgency may indicate how urgent the goal is (i.e., a braking discomfort level) and can influence details (e.g., how much braking to incur, how hard to brake, etc.) of how the lower-level planning systems cost and solve for trajectories to enable the scenario. The behavioral flags may indicate default behaviors of the autonomous vehicle that should be ignored at the planner layer, such as keep clear, tight waypoint following, reverse allowed, conservative rear time to clear (e.g., rear end risk), creeping, and so on.

In one embodiment, the scenario manager 530 may maintain scenario libraries 536 to reference in order to determine which parameters should be encoded in a scenario 540 that is generated to fulfill (at least partially) a mission 525. For example, the scenario library 536 may indicate what priority values, urgency values, goal parameters, behavioral flags to set (based on the contextual elements of the autonomous vehicle) in order to indicate a particular response intent in the scenario 540 generated by the scenario encoder 532. In some embodiments, the scenario library 536 may map the contextual information of the state/context 550 of the autonomous vehicle to the parameters that are set in the scenario 540.

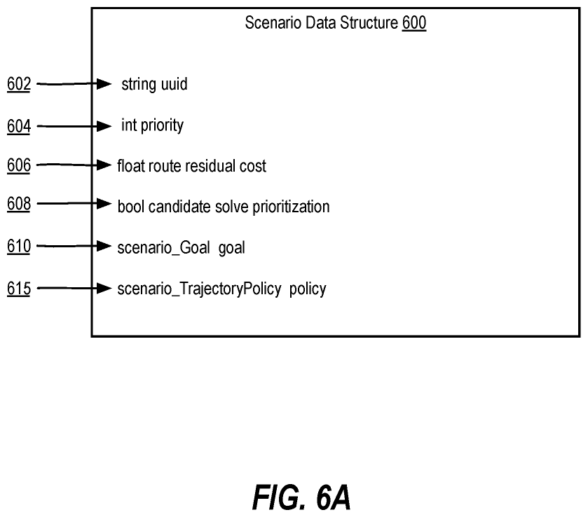

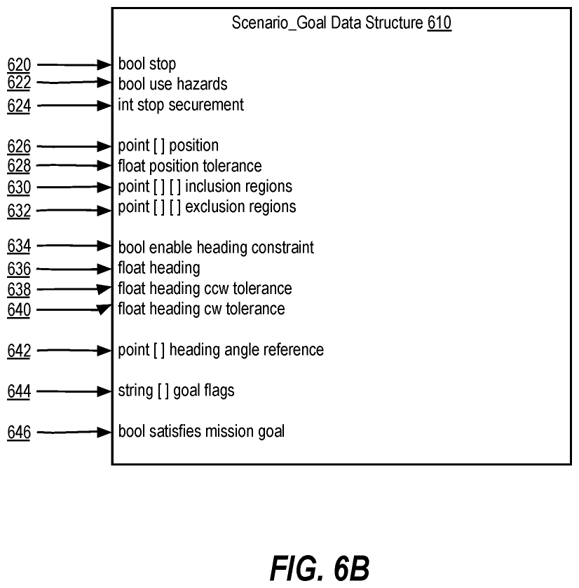

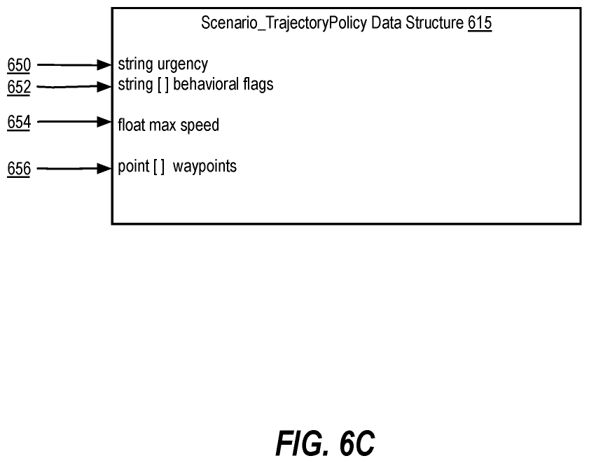

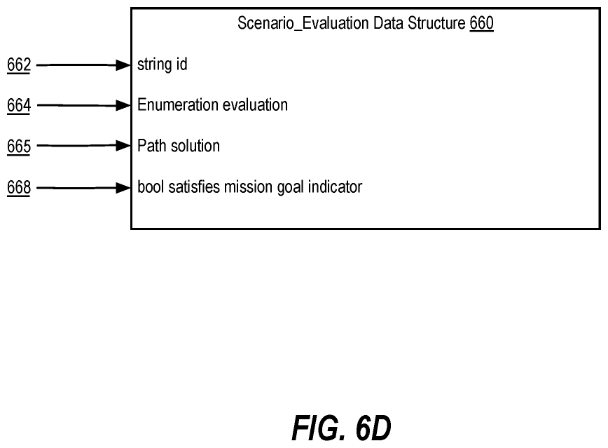

FIGS. 6A through 6D detail an example scenario API data structures for specifying goals and behavioral parameters for planning systems of autonomous vehicles, in accordance with embodiments herein. The scenario API data structures may be just one example of a possible format that a scenario, such as scenario 540 of FIG. 5, may take. Embodiments herein are not solely limited to the example format depicted and described herein, and other formats may be implemented for a scenario in accordance with embodiments described herein. For instance, the scenario message format may include more or less parameters that illustrated and described herein. In another example, the scenario API may encompass the scenarios being communicated in any of a variety of different formats for conveying information, such as a table structure, a tree structure, etc.

FIG. 6A depicts an example core structure of a scenario data structure 600, in accordance with one embodiment. The scenario data structure 600 may include one or more parameters 602-615. The parameters 602-615 may be fields or some other format of data. The parameters 602-615 can include an identifier 602 (uuid) of the scenario. The parameters also include a priority value 604 (priority) of the scenario. The priority value 604 may refer to an overriding priority that is useful for ranking a set of goals in a local scene. In one embodiment, the priority value 604 is a number/ranking that is assigned by the scenario manager. In some cases, there does not have to be a global priority (i.e., EMV=priority 4000), just so long as there is an order. In one example, if a lower priority scenario is satisfiable over a higher priority scenario, then it may be chosen. If a set of scenarios of identical priority are all valid, the scenario chosen may be based on the particular planner implementation. In one embodiment, the priority value 605 may be represented as a value from 0-2, where 0 is the highest priority and 2 is the lowest priority. Other representations of priority value 605 are also possible in embodiments herein.

The parameters may also include a route residual cost 606. In the case that a scenario is specifying a goal that does not fulfill the overall mission goal, the route residual cost 606 can represent a global “route” cost that remains once the goal of the scenario is satisfied. In some embodiments, this can be expressed in an estimate time to arrival (ETA), a distance, a risk, and so on. This route residual cost 606 parameter value may change over time. In one embodiment, route residual cost 606 can be used by the planner to trade-off local cost concerns (e.g., comfort, etc.) with global route-level implications.

The candidate solve prioritization 608 parameter can provide an indication for the planner to prioritize solving the particular scenario, but not execute it. This can be useful for RA-based scenarios, for example. In some embodiment, the candidate solve 608 parameter can provide a means for forcing the scenario to be solved by the planner.

The goal 610 parameter specifies the end state of the scenario and any constraints on that end state. The goal 610 parameter provides for a set of acceptable autonomous vehicle poses (boundaries and/or positions) that define the goal state, as well as a set of behavioral flags that determine auxiliary concerns of the desired goal state (e.g., hazards, parking brake, whether foal is to occur at velocity (v)=0 and be terminal, etc.). Additional details of the goal 610 parameter and its corresponding parameters are discussed with respect to FIG. 6B below.

The trajectory policy 615 (policy) parameter specifies details of how the planner should internally cost trajectories, which control how aggressively the planner may attempt to fulfill a scenario. Further details of the trajectory policy 615 parameter and its corresponding parameters are discussed with respect to FIG. 6C below.

FIG. 6B depicts an example core structure of a scenario goal data structure 610, in accordance with one embodiment. The scenario goal data structure 610 may be just one example of a possible format that a scenario goal data structure may take. Embodiments herein are not solely limited to the example format depicted and described herein, and other formats may be implemented for a scenario in accordance with embodiments described herein. For instance, the scenario goal message format may include more or less parameters that illustrated and described herein.

The scenario goal data structure 610 may include one or more parameters 620-646. The parameters can include stop-centric request flags, such as stop 620, use hazards 622, and stop securement 624 parameters, for example. The stop 620 parameter may indicate whether the scenario is requesting the autonomous vehicle to come to a stop. For example, when set (e.g., to a value of 1; stop is true), the stop 620 parameter indicates the autonomous vehicle is given a scenario goal (i.e., end state) to come to a stop. When not set (e.g., to a value of 0; stop is false), the stop 620 parameter indicates that the autonomous vehicle is given a scenario goal (end state) to continue driving (e.g., go to a particular destination, continue following a lane center line, etc.).

The use hazards 622 parameter may be referenced when the stop 620 parameter is true (e.g., is set; set to a value of 1). When the stop 620 parameter and the use hazards 622 parameter are both set, the autonomous vehicle may be caused to activate its hazard lights before coming to a stop. In some embodiments, an implementation-specific time may be configured (e.g., when autonomous vehicle begins slowing down, when stop is fully completed, etc.) for when to activate the hazard lights. In some embodiments, the use hazards 622 parameter can be combined together in a lower-level blinker aggregation layer of the planner to determine whether hazards should be activated.

The stop securement 624 parameters may be referenced when the stop 620 parameter is true. When the stop parameter 620 and the stop securement 624 parameter are both set, the autonomous vehicle may be caused to deploy additional stop securement mechanisms during the stop. Such stop securement mechanisms may include values or indicators to implement holding in place, electric parking brake, shifting gear in park, shifting gear into park and applying the electric parking brake, and so on. In one example implementation of the scenario, the stop securement 624 parameter may specify one or more values including a representation for applying the parking brake, a representation for shifting to park, and so on, to indicate the stop securement mechanism to implement.

In some embodiments, the parameters can further include, but are not limited to, a set of parameters to specify pose constraints for the end state of the goal, such as position 626, position tolerance 628, inclusion regions 630, exclusion regions 632, enable heading constraints 634, heading 636, heading counterclockwise (ccw) tolerance 638, heading clockwise (cw) tolerance 640, heading angle reference 642, goal flags 644, and satisfies mission goal 646, for example.

The position 626 parameter specifies one or more positions in terms of the leading center of the autonomous vehicle. For example, this can be the front bumper when going forward or the rear bumper when going in reverse. Multiple positions may be specified and how such multiple positions are prioritized may be left to the implementation-specific details of the planner.

The position tolerance 628 parameter specifies a radial tolerance around a position that is considered acceptable for the autonomous vehicle. In one embodiment, if the position tolerance is not specified, then the position tolerance 628 for position 626 can be interpreted as “best effort”.

The inclusion region 630 parameter specifies a region that the autonomous vehicle should end up in when reaching the end state of the goal of the scenario. If the inclusion region 630 parameter is not specified, then it may be assumed that any end state final location is acceptable. For example, if the scenario goal is a stop end state, the inclusion region can specify an acceptable region of the map that the autonomous vehicle may stop in. Conversely, the exclusion region 632 parameter specifies a region that the autonomous vehicle should not end up in (is not allowed to stop in) when reaching the end state of the goal of the scenario.

The enable heading constraint 634, heading 636, heading ccw tolerance 638, and heading cw tolerance 640 parameters specify whether heading angles are indicated as applying to the autonomous vehicle. If heading angle constraints are set by the enable heading constraint 634 parameter, then the heading 636, heading ccw tolerance 638, and heading cw tolerance 640 parameters can specify what those heading angle(s) 636 are, including tolerance levels (ccw 638 and cw 640) associated with the heading angles.

The heading angle reference 642 parameter provides a linestring that can be used to project the autonomous vehicle's position and look up the desired heading. This heading angle reference 642 parameter can offset the absolute heading angle specified by heading 636 if present.

The goal flags 644 parameter provides a flag that can indicate any additional constraints to apply to the particular goal of the scenario_goal data structure 610. The goal flags 644 parameter allows for additional expansion of the set of constraints that may apply to the goal as the underlying low-level planning architecture changes and adapts.

The satisfies mission goals 646 parameter provides a flag that can effectively describe when a mission's goal is reachable by the scenario goal. When set (e.g., value set to 1; true), the satisfies mission goals 646 parameter indicates that executing the particular scenario can result in mission completion. When not set (e.g., value set to 0; false), the satisfies mission goals 646 parameter indicates that the ultimate mission goal is still beyond the horizon.

FIG. 6C depicts an example core structure of a scenario trajectory policy data structure 615, in accordance with one embodiment. The scenario trajectory data structure 615 may be just one example of a possible format that a scenario trajectory policy message may take. Embodiments herein are not solely limited to the example format depicted and described herein, and other formats may be implemented for a scenario in accordance with embodiments described herein. For instance, the scenario trajectory policy message format may include more or less parameters that illustrated and described herein.

The scenario trajectory policy data structure 615 may include one or more parameters 650-656, such as urgency 650, behavioral flags 652, maximum speed 654, and waypoints 656, to name a few examples.

The urgency 650 parameter indicates an abstract notion of urgency and/or discomfort. The urgency 650 parameter can influence the internal details of how the planner costs and solves for trajectories to satisfy the scenario. In one embodiment, the urgency 650 parameter can correspond to a rough level of discomfort that is mapped to various kinematic parameters of the planner in an implementation-specific way. In one embodiment, example values of the urgency 650 parameter can include values indicating a low urgency (e.g., low braking, comfortable stop), a medium urgency (e.g., moderate, quick stop), and a high urgency (e.g., high, full physical braking authority of the autonomous vehicle).

The behavioral flags 652 parameter provides a way to turn off certain default behaviors of the autonomous vehicle. For example, the behavioral flags 652 may include one or more values representing the capabilities of: allowing for a larger rear buffer of the autonomous vehicle, allowing for slow re-positioning of the autonomous vehicle to a safe location after the stop (e.g., creeping), allowing for pulling into curb lanes, allowing expanded ability to pull into parking zones, and so on. If any of these values are set in the behavioral flags 652 parameter, then the planner may override specific correlated default behaviors of the autonomous vehicle. For example, if the value representing allowance for a larger rear buffer of the autonomous vehicle is indicated in the behavioral flags 652 parameter, then the default behavior of the autonomous vehicle of a default following distance in the time domain may be overridden by the planner in accordance with the planner-specific implementation. Any number of other behavioral flag parameter values may be implemented in embodiments herein and are not solely limited to the examples discussed above.

The maximum speed 654 parameter can specify a maximum speed (e.g., in meters per second, miles per hour, etc.) that the planner allows the autonomous vehicle to achieve. If the autonomous vehicle is currently going faster than this maximum speed, then the planner can cause the autonomous vehicle to ramp down in a comfortable manner.

The waypoints 656 parameter provides a set of waypoints the trajectory should travel through. In one embodiment, the tolerance for this set of waypoints can be implemented using a behavioral flag. In some embodiments, this can be split out into an explicit numeric field.

Although not specifically illustrated in FIGS. 6A-6C, other parameters may be specified in the scenario message format. For example, in some embodiments, additional scene directives may be included in the scenario message format. Such scene directives can provide context to the planner with respect to the local scene of the autonomous vehicle. For example, the scene directives can describe aspects about the local scene that should be considered when generating trajectories at the planner. Examples of scene directives can include lane boundary information, legal speed limit, keep clear zones, traffic light states, yield graphs, speed bumps, and so on. The planner can consider these scene directives when attempting to satisfy a scenario. In other embodiments, the sophisticated planner implementation can obtain and consider the scene directive information without having to specifically specify it in the scenario itself.

Referring back to FIG. 5, the specific parameters (such as the parameters 602-656 of FIGS. 6A-6C) to apply to a scenario 540 can be maintained in the scenario library 536. Furthermore, the scenario library 536 may indicate other options for potential scenarios 540, such as options for lateral road clearance to maintain in a scenario 540, fallback behaviors that are allowed (e.g., behaviors that can occur should the scenario's goal not be satisfied), options for single lane roads versus multi-lane roads, options for one-way roads, options for biasing within a lane or out of a lane, options for autonomous vehicle hazards and turn signal light usage, options for parking brake usage, and so on.

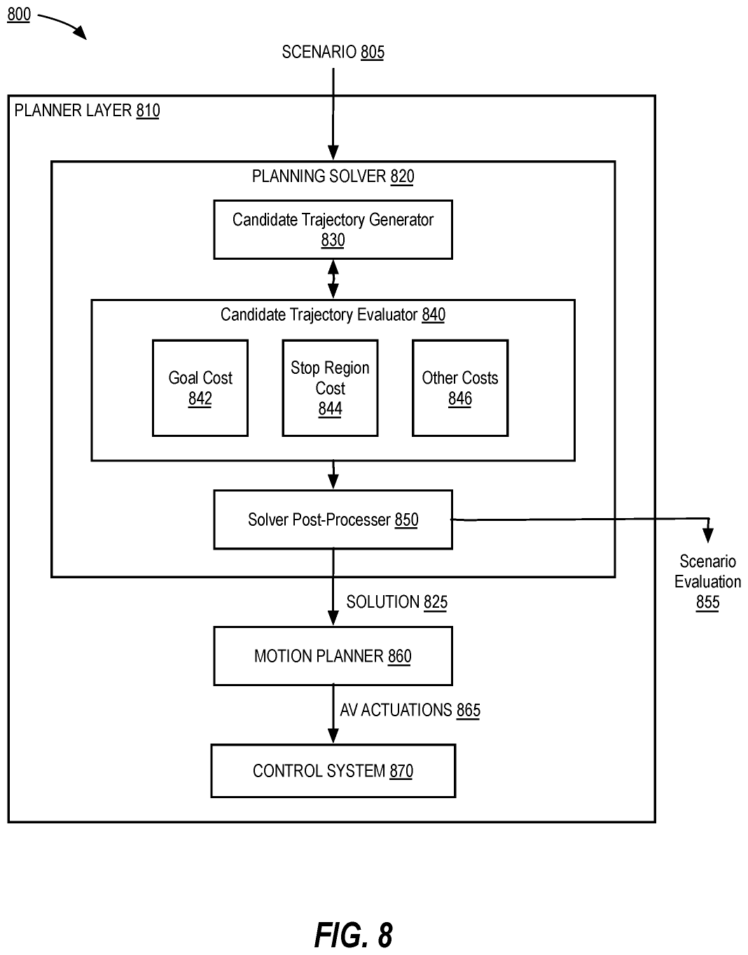

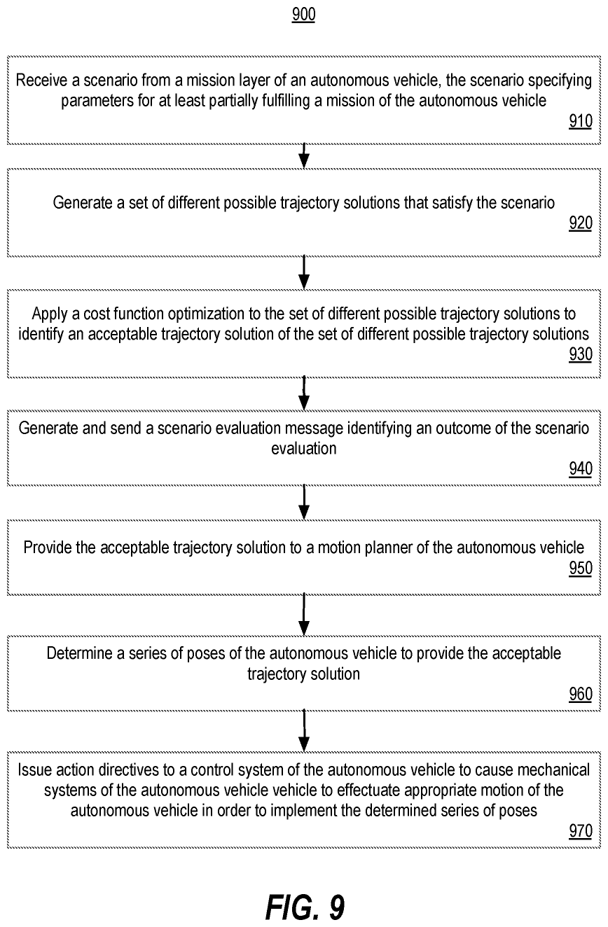

Once the scenario manager 530 generates the one or more scenarios 540 to fulfill the mission 525, the list of scenarios 540 can be published to a planner layer (e.g., planner layer 330 of FIG. 3) of the autonomous vehicle. Further details of processing of the generated scenarios by the planner layer can be found below with respect to FIGS. 8-9.

Once a planner solves and costs for a particular scenario 540, the planner may provide feedback on the solving and costing of the scenario 540 via a scenario evaluation 560. In one embodiment, the scenario evaluation 560 is the same as scenario evaluation 340 described with respect to FIG. 3. After the planner (such as planner layer 330 of FIG. 3) finishes solving and costing a scenario, it publishes an outcome of the scenario (e.g., whether scenario was satisfied, etc.). This can be utilized by the mission layer 510 to track progress towards scenario completion and manage the current portfolio of active scenarios with respect to how they map to overall mission objectives. In some embodiments, the scenario evaluation 560 can be utilized by the mission layer 510 to initiate in-car feedback and/or passenger (“rider”) device interface tasks (i.e., information the passenger that the autonomous vehicle is pulling over, informing the passenger that the autonomous vehicle is stopping for an emergency vehicle, etc.)

FIG. 6D depicts an example core structure of a scenario evaluation data structure 660, in accordance with one embodiment. In one embodiment, the scenario evaluation data structure 660 may be the same as scenario evaluation 340 of FIG. 3 and/or scenario evaluation 560 of FIG. 5. The scenario evaluation data structure 660 may be just one example of a possible format that a scenario evaluation message may take. Embodiments herein are not solely limited to the example format depicted and described herein, and other formats may be implemented for a scenario in accordance with embodiments described herein. For instance, the scenario evaluation message format may include more or less parameters that illustrated and described herein.

The scenario evaluation data structure 660 for a scenario_evaluation.msg may include one or more parameters 662-668, such as an identifier 662 (id), an evaluation 664, a solution 665, and a satisfies mission goal indicator 668, for example. Further details of these example parameters are discussed further below.

The identifier 662 parameter may identify the scenario for which the scenario evaluation data structure 660 corresponds to. The value of the identifier 662 parameter may be an ID of the scenario.

The evaluation 664 parameter identifies the outcome of the planner's solving and costing of the scenario identified by identifier 662. In one embodiment, the possible outcomes can include, but are not limited to, satisfied, planned, infeasible, unattempted, or unsupported, for example. More or less possible outcomes and representative values for the evaluation 664 parameter are contemplated by embodiments herein and are not limited to those discussed herein. The ‘satisfied’ evaluation indicates that the initial pose of the autonomous vehicle currently meets the goal conditions of the scenario. The ‘planned’ evaluation indicates that the autonomous vehicle is planning to the meet the goal conditions of the scenario (e.g., planning on satisfying). The ‘infeasible’ evaluation indicates that the planner does not believe the scenario can be satisfied (e.g., cannot stop ahead of time, conflicting parameters (such as inclusion and exclusion regions overlap), asking to brake harder than possible, braking parameter that is allowed does not enable to stop in inclusion region, etc.). The ‘unattempted’ evaluation indicates that the planner did not attempt to solve this scenario (e.g., compute constraints prevent the planner from scheduling solves for all candidate scenarios on every tick (clock cycle) of the autonomous vehicle systems). The ‘unsupported’ evaluation indicates that the planner does not support some set of requisite goal parameters in the scenario (e.g., a field in the scenario API message does not have a corresponding actual implementation hooked up in the planner).

In one embodiment, if the evaluation 664 parameter is indicated as satisfied or planned, then the solution 665 parameter can include the planned trajectory generated by the planner.

The satisfies mission goal 668 parameter provides a flag that can effectively describe when a mission's goal is reachable by the scenario goal. The satisfies mission goal 668 parameter may be similar to the satisfies mission goal 646 parameter of FIG. 6B in the scenario_goal.msg format. When set (e.g., value set to 1; true), the satisfies mission goals 668 parameter indicates that executing the particular scenario can result in mission completion. When not set (e.g., value set to 0; false), the satisfies mission goals 668 parameter indicates that the ultimate mission goal is still beyond the horizon.

Referring back to FIG. 5, the scenario evaluation 560 may be utilized by the mission manager 520 and/or the scenario manager 530 to select a mission and/or generate scenarios 540 in accordance with the scenario evaluation 560. The scenario manager 530 may maintain feedback from the scenario evaluation 560 in scenario data store 538, and utilize scenario feedback component 534 to provide hints and suggestions to scenario encoder 532 when generating the scenarios 540 for a ranked mission 525. The scenario feedback component 534 may also utilize the scenario evaluation to cause notifications to be generated for the autonomous vehicle. For example, if a scenario is indicated as satisfied and the mission goal is also complete, then a passenger of the autonomous vehicle may be notified that the vehicle is pulling over (or has already pulled over). Furthermore, if a scenario is indicated as infeasible or unsupported, the scenario feedback component 534 may inform the scenario encoder 532 to de-prioritize that scenario if it is being generated again.

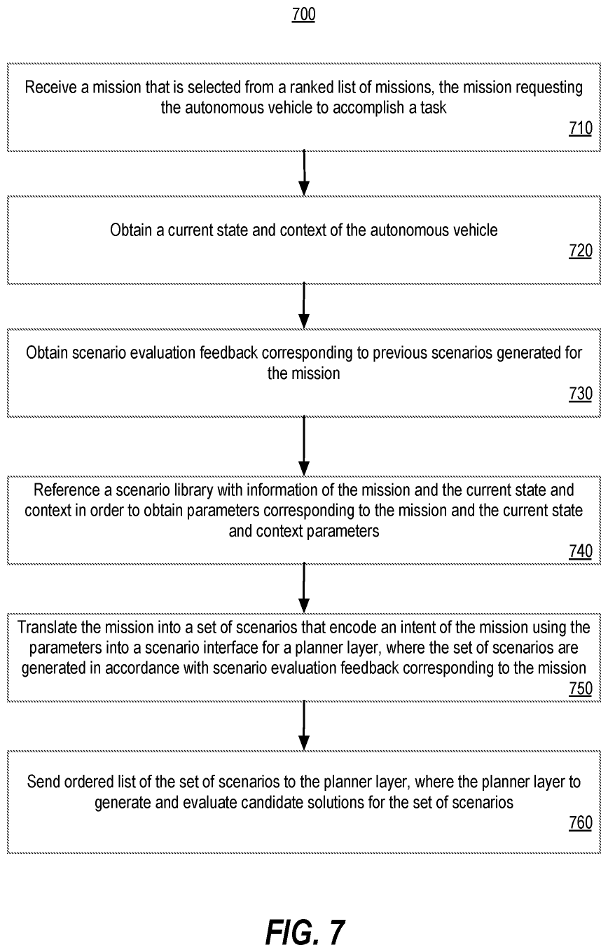

FIG. 7 illustrates an example method 700 for generating a scenario from a received mission, in accordance with embodiments herein. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

According to some embodiments, the method 700 includes block 710 where a mission is received that is selected from a ranked list of missions. In one embodiment, the mission requests the autonomous vehicle to accomplish a task and the mission is presented in abstract terms.

At block 720, a current state and context of the autonomous vehicle is obtained. In one embodiment, the current state and context may be obtained from perception systems of the autonomous vehicle. The current state and context may include scene context of the autonomous vehicle, such as local scene information (e.g., parked vehicles, emergency vehicles, keep clear zones, etc.) and global router lane graph information. At block 730, scenario evaluation feedback can be obtained that corresponds to previous scenarios generated for the mission. In one embodiment, the scenario evaluation feedback may be maintained in a data store of the mission layer of the autonomous vehicle. The scenario feedback evaluation may be generated by a planner layer of the autonomous vehicle in response to generation of previous solutions to one or more scenarios for the mission.

Subsequently, at block 740, a scenario library is referenced with information of the mission and the current state and context in order to obtain parameters corresponding to an intent of the mission and the current state and context information. In one embodiment, the scenario library is maintained by the mission layer of the autonomous vehicle and maps mission intent and/or state/context information to a variety of parameters used to generate a scenario. The parameters can include any of the parameters 602-668 described with respect to FIGS. 6A-6C above, such as priority, goal state (and its sub-parameters), trajectory policy (and its sub-parameters), and so on.

At block 750, the mission is translated into a set of scenarios that encode an intent of the mission using the parameters obtained from the scenario library at block 740. In one embodiment, the parameters are encoded into the set of scenario in accordance with a scenario interface (e.g., scenario API) for a planner layer. In one embodiment, the set of scenarios are further generated in accordance with scenario evaluation feedback corresponding to the mission.

Lastly, at block 760, an ordered list of the set of scenarios is sent to the planner layer. In one embodiment, the planner layer is to generate and evaluate candidate solutions (e.g., proposed trajectories) for the set of scenarios. In some embodiments, the list of the set of scenarios is ordered in accordance with the priorities of the scenarios. In some embodiments, the list of the set of scenarios is ordered in accordance with a performance order that the scenarios should be performed and then sub-ordered in accordance with the priorities of the scenarios. In some embodiments, a single scenario is generated and sent to the planner layer for the mission.

FIG. 8 illustrates an autonomous vehicle 800 implementing a planner layer 810 for specifying goals and behavioral parameters for planning systems of the autonomous vehicle, in accordance with embodiment herein. In one embodiment, the planner layer 810 is the same as planner layer 330 described with respect to FIG. 3. As illustrated, in one embodiment, the planner layer 810 may include a planning solver 820, a motion planner 860, and a control system 870. In embodiments herein, the planning solver 820, the motion planner 860, and the control system 870, as well as their sub-components, may be implemented by hardware, software, firmware and/or any combination of hardware, software and/or firmware of a computing system.

In embodiments herein, the planner layer 810 receives one or more scenarios 805, which are resolved into one or more concrete trajectories by the planner layer 810. The planner layer 810 can resolve any final degrees of remaining freedom left in the scenario 805 by prescribing a sequence of poses and optimizing for safety and comfort. In one embodiment, the planner layer 810 can accept a proposed and prioritized set (one or more) of scenarios 805 from a mission layer (e.g., mission layer 510 described with respect to FIG. 5), solve the scenarios 805 leveraging the priority (of the scenarios 805), execute a best candidate scenario, report information about the solutions to the mission layer, and produce trajectory plans for the control system 870, which can generate and send vehicle command signals to the mechanical systems of the vehicle 800 based on the trajectory plans.

In one embodiment, the planner layer 810 can include a planning solver 820 which may be the same as planning preprocessor 332 and planning solver 334 of FIG. 3. As previously noted, a planning preprocessor condenses driving concerns into a format that the planning solver 334 can operate on and any intermediate scene preprocessing, as needed. Examples can include exact pullover location selection, emergency vehicle response, etc.

In one embodiment, the planning solver 820 may be a trajectory solver (sampling methods, graph methods, gradient search methods, analytic candidate iteration and evaluation methods, ML-derived trajectory generation, etc.) capable of receiving a scenario 805 and computing a corresponding trajectory (e.g., solution 825) to satisfy the scenario 805. Other types of planning solvers 820 may also be utilized in embodiments herein. In embodiments herein, there can be more than one planning solver 820 (e.g., nominal and fallback stacks) implemented in the planner layer 810, and each planning solver 820 can internally use several different algorithms and solvers. Utilization of the common scenario API described herein by the different planning solvers 820 allows for abstraction of the behavioral parameters implemented by the planning solvers 820 from the upstream systems providing input via the mission layer (such as mission layer 320 of FIG. 3).

In one embodiment, the planning solver 820 may include a candidate trajectory generator 830, a candidate trajectory evaluator 840, and a solver post-processor 850. More or less components of planning solver 820 may be implemented by embodiments herein, and are not solely limited to the components described herein. The candidate trajectory generator 830 may utilize the parameters provided in the scenario 805 (e.g., priority, goals, trajectory policy (urgency, behavioral flags, etc.), etc.) to generate multiple different possible trajectory solutions that can satisfy the scenario 805. In one embodiment, the candidate trajectory generator 830 maintains a mapping of the scenario parameters to one or more behavioral components of the autonomous vehicle used as part of the trajectories generated by the candidate trajectory generator 830. The candidate trajectory generator 830 can utilize this mapping to generate the possible trajectory solutions.

The candidate trajectory evaluator 840 may then utilize a cost function optimization approach to generate a cost for each of the possible trajectory solutions generated by candidate trajectory generator 830 and select one of the possible trajectory solutions to output as an optimum or acceptable trajectory (i.e., solution 825) for the autonomous vehicle. In one embodiment, the candidate trajectory evaluator 840 may utilize costs including goal cost 842, stop region cost 844, and/or other costs 846 in its cost function optimization approach. The candidate trajectory evaluator 840 may evaluate the possible trajectory solutions and utilize, for example, a cost comparator (not shown) to select the trajectory solution 825 that has a lowest cost.

The following discussion provides some example implementation details of how the candidate trajectory evaluator 840 may cost possible trajectory solutions generated by the candidate trajectory generator 830. These details are planning solver 820 implementation specific and may vary with respect to embodiments herein.

With respect to goal cost 842, the goal cost 842 can evaluate whether a scenario's 805 specified goal is satisfied. Various approaches for evaluation may be applied in embodiments herein. In one example, the evaluation of whether the scenario's 805 specified goal is satisfied applies an approach of costing against trajectories that do not satisfy it. Other evaluation approaches may also be implemented and are not limited to the specific costing implementation discussed herein.

In one embodiment, the goal cost 842 can provide context to the candidate trajectory generator 830 so that it can generate subsequent trajectories that do satisfy the goal of the scenario 805. As previously discussed, the goal of a scenario 805 can be specified as either a stop (stop goal) or go (go goal) (e.g., not stop, Go to, Continue at speed, etc.). A go goal can map to a default behavior of the planning solver 820 so that the planning solver 820 attempts to make as much forward progress as possible along its reference as possible. In some embodiments, in the case of a go goal, the candidate trajectory generator 830 may be initialized with a default positive desired acceleration value.

A stop goal can map to the planning solver's 820 objective to eventually come to a stop (i.e., v=0) at some point, subject to the list of constraints and parameters that the scenario 805 specifies. At minimum, the candidate trajectory generator 830 can be provided with a constraint that enforces that the velocity eventually reaches 0 and the desired acceleration is to be negative. The specifics of these constraints and desired acceleration parameters are context- dependent. As such, the goal parameter of the scenario 805 may intentionally not dictate particular formulations or values.

In one embodiment, the formulation of the goal cost 842 may be provided as follows: When the goal type is a go goal (e.g., continue at current speed) and other constraints are also satisfied, the goal cost 842 can return a value of 0. In some embodiments, violating any of the constraints may result in a non-zero cost for that trajectory.

When the goal type is a stop goal (e.g., STOP), the goal cost 842 may be calculated as follows: The urgency parameter of the goal is read and mapped to a maximum amount of allowable deceleration. Each of the constraints attached to the goal in the scenario 805 is then evaluated and its cost contribution is added to the overall goal cost 842.

In some embodiments, the goal cost 842 can be provided as part of an ordinal cost structure of the candidate trajectory evaluator 840. In one example, the goal cost 842 may be provided at a level above a discomfort severity cost. In some embodiments, the scenario API urgency can also allow for directly accepting different amounts of braking discomfort by modifying parameters of other costs being considered by the candidate trajectory evaluator 840 This allows for the candidate trajectory evaluator 840 to directly accept different amounts of braking discomfort, which is utilized to implement the urgency component of the trajectory policy of the scenario 805. If the goal cost 842 is placed below the discomfort severity cost in the cost structure, then a threshold of discomfort severity cost may have to be dynamically changed to allow for higher amounts of braking. The embodiments of the scenario API described herein allow for sufficient flexibility to swap out this mechanism without having to make any external API changes.

With respect to stop region cost 844, the stop region cost 844 can also be provided as part of the ordinal cost structure of the candidate trajectory evaluator 840. The stop region cost 844 can depend on the goal type (e.g., stop goal or go goal) of the scenario 805. If the goal of the scenario 805 is a go goal (e.g., goal parameter is set of false), the planning solver 820 may try to make as much progress as possible along the reference subject to constraints from the various tactics.

If the goal of the scenario 805 is a stop goal, the planning solver 820 may cost the stop region cost 844 as follows: If the autonomous vehicle does not come to a stop at all, or does not fully stop with its footprint entirely contained within an acceptable stop region, a cost is incurred. If a nominal stop location is set, an additional error cost is added, proportional to the distance between the nominal stop location and the position of the central point of the autonomous vehicle front bumper. In some embodiments, if the autonomous vehicle stops outside of an acceptable stop region, or does not stop at all, the yield or assert constraints provided to the candidate trajectory generator 830, corresponding to the near and far travels of the stop region, are corrected to account for the geometry of the autonomous vehicle.

Further example details of the stop goals and their contribution to stop region cost 844 are provided below, delineated by the constraints provided for the stop goals in the scenario 805. The description below is in accordance with one example possible planner implementation and does not limit other potential planner-specific implementation of the embodiments described herein.

For stop goals with an undefined goal region (e.g., no goal region is set), the candidate trajectory generator 830 may avoid directly prescribing specific stopping locations, since this type of stop intends to forgo control of the exact stopping position in favor of conveying a general desire to slow and come to a stop. This allows the candidate trajectory generator 830 to determine how to most comfortably do that. In these cases, the stop region cost 844 may check two things: 1) whether the solution eventually comes to a stop, and 2) if the solution stops before a stop location implied by a maximum acceptable deceleration derived from the scenario's 805 trajectory policy parameters to account for comfort.

In a candidate trajectory evaluator 840 using an evaluation approach implementing branches, the stop region cost 844 of solution may be determined based on an if/else approach. For example, in some embodiments, when the actual or planned velocity of the AV meets a threshold (e.g., the velocity of the AV is greater than an approximate stopped velocity of the AV) then the stop region cost 844 is set to a first value. In some embodiments, when both of the above conditions are not met, the stop region cost 844 is set to a second value. In some embodiments, the first value is greater than the second value (e.g., the second value is 0 and the first value is some positive integer or floating point value).

At the beginning of the pseudocode presented above, the root branch's initial desired acceleration is set to a nominal negative value, which is a fraction of the maximum allowable deceleration. The candidate trajectory generator's 830 reference cost and comfort tuning is then relied upon to comfortably bring the autonomous vehicle to a stop. Any goal-related position, speed, or acceleration constraints may not necessarily be populated for such a scenario 805.

In some embodiments, for all stop goals, a delay cost may also be inverted to choose branches that make the least time-weighted forward travel of all otherwise-acceptable branches. This naturally encodes that, all else equal, unnecessarily delaying coming to a stop should be avoided.

For stop goals with a defined goal region (e.g., where a goal region is set), it may be considered unacceptable to stop outside the region. The candidate trajectory generator 830 considers stopping anywhere within the region as acceptable and preferably should do so as soon as possible, subject to the scenario's 805 trajectory policy urgency parameter value.

The same checks for stop goals with undefined goal regions discussed above also apply. In addition, a spatial check may also be provided to ensure that the autonomous vehicle's footprint lies completely within the region. For example, for a candidate trajectory evaluator 840 using an evaluation approach implementing branches, the stop region cost 844 of the solution can be determined based on an if/else approach. For example, in some embodiments, when the goal boundaries do not fall within the footprint of the stopping area of the autonomous vehicle, then the stop region cost 844 is set to a first value (e.g., a high value). When the actual or planned velocity of the AV meets a threshold (e.g., the velocity of the AV is greater than an approximate stopped velocity of the AV) then the stop region cost 844 is set to a first value. In some embodiments, when both of the above conditions are not met, the stop region cost 844 is set to a second value. In some embodiments, the first value is greater than the second value (e.g., the second value is 0 and the first value is some positive integer or floating point value).

In these cases, the root branch's desired acceleration is not set to a negative value. Instead, the desired acceleration may be kept at its default positive value and speed constraints may be provided to bring the autonomous vehicle to a stop. A candidate trajectory may be selected if speed constraints result in the final stopping location lying in a space bounded by the boundaries of the region. In one example embodiment, two speed trajectory generation constraints can be generated: one for the travel of the beginning of the region and one for the travel of the end of the region (as stopping any shorter or later may be considered unacceptable).

In some embodiments, depending on the particular planner layer implementation, these travels can be adjusted as follows: Trajectory generation constraint travels are set to account for the length of the autonomous vehicle, since the full autonomous vehicle should be within the region, not just its navigation reference. Trajectory generation constraint travels may also be adjusted so they do not lie before the autonomous vehicle's minimum acceptable stop travel (e.g., s=max(s,min_acceptable_stop_travel(max_decel)). This prevents generating branches that are known to brake unacceptably hard. It also accounts for situations where the autonomous vehicle starts within the region. In these cases, the default travel would otherwise be negative and ignored. With this adjustment, the branch's travel instead takes the autonomous vehicle to a stop as soon as acceptably possible. The time value of a trajectory generation speed constraint can be set to the earliest time that the parent branch exceeds its travel and is extended to the horizon to prevent further forward motion after the solution comes to a stop.

For stop goals with desired positions set (e.g., specifying a desired location within its goal region), the planning solver 820 can attempt to bring the autonomous vehicle's front bumper to the location using a best effort. As this desired position is a suggestion, treating it at the same level of precedence as the goal region or the urgency, which are goal constraints, may not be appropriate. Instead, the desired position is closer in concept to a reference for the final position of the solution.

If the desired position is set, the delay cost can equal a squared position error (e.g., in travel space; L2 norm) between the front bumper of the autonomous vehicle and the desired stop location. This allows for preferring branches that get closer to the desired stop location should all other costs be satisfied.

In one example implementation, the delay cost (e.g., other cost 846) of the solution, when utilizing an evaluation approach implementing branches, can be expressed by implementing comparisons. For example, in some embodiments, when the goal is not a stop goal, then the delay cost can be adjusted (reduced) by a first value based on an accumulated weighted travel amount. When a specific desired position of the autonomous vehicle is not defined and if the autonomous vehicle has not yet traveled along a determined path towards a determined position, then the delay cost can be adjusted (increased) by the first value based on the accumulated weighted travel amount. Otherwise, if the delay cost is adjusted by an error value. In some embodiments, the error value can be based on a second value corresponding to an amount the autonomous vehicle has traveled toward the desired position.

In some embodiments, to make available a candidate branch that stops at the desired position, a branch can be additionally requested with the desired position's travel as a position constraint using the constraint generation method described above.

With respect to other costs 846, the other costs 846 can also be provided as part of the ordinal cost structure of the candidate trajectory evaluator 840. In one embodiment, costs associated with the trajectory policy of the scenario 805 may be determined by the candidate trajectory evaluator 840. The trajectory policy parameters of the scenario 805 allow for context-specific, but implementation-agnostic, customization of how the planning solver 820 can satisfy its goal. In the long term, this can provide a composable, semantic library of trajectory customization options. In the short term, only a handful of functions might be implemented.

As discussed above, the scenarios 805 allows for specifying an acceptable amount of discomfort (e.g., urgency parameter 650 of FIG. 6C) incurred when satisfying a goal. This is utilized because certain stop behaviors dictate sacrificing comfort in favor of urgency. In one example embodiment, three levels of urgency (e.g., maximum discomfort) may be supported: a low urgency (e.g., low braking, comfortable stop), a medium urgency (e.g., moderate, quick stop), and a high urgency (e.g., high, full physical braking authority of the autonomous vehicle.

One example implementation of costing for the urgency parameter is detailed as follows:

Low urgency: The goal cost 842 allows up to, for example, −2 m/s^2 deceleration. The reference desired acceleration provided to the candidate trajectory generator 830 is, in one example, −1.8 m/s^2.

Medium urgency: The goal cost 842 allows up to, for example, −3.5 m/s^2 deceleration. The reference desired acceleration provided to the candidate trajectory generator 830 is, in one example, −2.7 m/s^2.

High urgency: The discomfort check in the goal cost 842 is skipped, allowing for the full use of the autonomous vehicle's braking capabilities. The reference desired acceleration provided to the candidate trajectory generator 830 is, in one example, −4 m/s^2.

In further reference to high urgency stop goals, if a scenario 805 sets the urgency parameter of its trajectory policy to high urgency, this may mean that the full braking authority of the autonomous vehicle is authorized for meeting its goal. In these cases, disabling some discomfort checks may be performed to achieve a desired behavior; namely: [symbol] goal cost 842 skips its minimum acceptable stopping distance check entirely, and the discomfort severity cost is skipped for the root branch and its children. This approach could also work with other mechanisms, such as changing a parameter of discomfort costs, modifying a coefficient/bias on this cost, modifying the types of discomfort (e.g. lateral vs. longitudinal) being considered, etc.

In one embodiment, behavior flag parameters of the trajectory policy of the scenario 805 may also be reflected in other costs 846. For example, when the ignore keep clear behavioral flag is set, the candidate trajectory evaluator 830 may stop specify that stopping in intersections is allowed. In some example embodiments, in order to prevent intersection commit regions generated for ‘keep clear’ from interfering with stop behavior, inputs from the planning preprocessor (e.g., planning preprocessor 332 of FIG. 3) that cause the candidate trajectory evaluator 803 to incur costs for stopping in intersections can be ignored.

In one embodiment, the solver post-processor 850 can annotate the solution 825 selected by candidate trajectory evaluator 840 with blinkers and/or hazards status as well as cause any gear requests to be performed. The solver post-processor 850 may then pass the trajectory solution 825 to the motion planner 860. In one embodiment, the solver post-processor 850 can also generate and share an evaluation for each received scenario 805 as a scenario evaluation 855. The scenario evaluation 855 may be the same as scenario evaluation 340 of FIG. 3 and/or scenario evaluation 560 of FIG. 5. In one embodiment, scenario evaluation 855 is formatted in accordance with the format of scenario evaluation data structure 660 described with respect to FIG. 6D. The mission layer (such as mission layer 320 of FIG. 3) of the autonomous vehicle can utilize the information from the scenario evaluation 855 to track progress towards scenario completion and manage a current portfolio of active scenarios.

The motion planner 860 may determine a series of poses (e.g., waypoints, velocities, and/or accelerations), for example, that the autonomous vehicle should take for the provided trajectory solution 825. The motion planner 860 can provide autonomous vehicle actuation 865 directives to the control system 870 to cause the mechanical systems of autonomous vehicle to effectuate appropriate motion of the autonomous vehicle in order to implement the determined series of poses for the trajectory solution 825 generated for the scenario 805. In one embodiment, the control system 870 is the same as control system 336 described with respect to FIG. 3.

FIG. 9 illustrates an example method 900 for generating a trajectory solution for a received scenario, in accordance with embodiments herein. Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

According to some embodiments, the method 900 includes block 910 where a scenario is received from a mission layer of an autonomous vehicle. In one embodiment, the scenario specifies parameters for at least partially fulfilling a mission of the autonomous vehicle. In one embodiment, the scenario is generated by a mission layer of the autonomous vehicle, as described with respect to FIGS. 5-7 above. The parameters can include any of the parameters 602-668 described with respect to FIGS. 6A-6C above, such as priority, goal state (and its sub-parameters), trajectory policy (and its sub-parameters), and so on.

At block 920, a set of different possible trajectory solutions are generated, where the set of different possible trajectory solutions satisfy the scenario. In one embodiment, a candidate trajectory generator of a planning solver, such as candidate trajectory generator 830 of FIG. 8, generates the set of different possible trajectory solutions for the scenario. Then, at block 930, a cost function optimization is applied to the set of different possible trajectory solutions to identify an acceptable trajectory solution of the set of different possible trajectory solutions. In one embodiment, a candidate trajectory evaluator may utilize one or more costs, such as a goal cost, a stop region cost, and other ordinal costs in its cost function optimization. The candidate trajectory evaluator may evaluate the possible trajectory solutions and utilize, for example, a cost comparator to select the acceptable trajectory solution that has a lowest cost.

At block 940, a scenario evaluation message is generated and sent to a mission layer of the autonomous vehicle. In one embodiment, the scenario evaluation message identifies an outcome of the scenario evaluation performed by the planning solver. In one embodiment, the scenario evaluation message is the same as scenario evaluation 340 of FIG. 3, scenario evaluation 560 of FIG. 5, and/or scenario evaluation 855 of FIG. 8. In one embodiment, scenario evaluation 855 is formatted in accordance with the format of scenario evaluation data structure 660 described with respect to FIG. 6D.

At block 950, the acceptable trajectory solution is provided to a motion planner of the autonomous vehicle. Then, at block 960, a series of poses of the autonomous vehicle is determined to provide the acceptable trajectory solution. In one embodiment, the motion planner determines the series of poses. The series of poses may include waypoints, velocities, and/or accelerations of the autonomous vehicle to cause the acceptable trajectory solution to be implemented by the autonomous vehicle.

Lastly, at block 970, one or more action directives are issued to a control system of the autonomous vehicle to cause mechanical systems of the autonomous vehicle to effectuate appropriate motion of the autonomous vehicle in order to implement the determined series of poses.

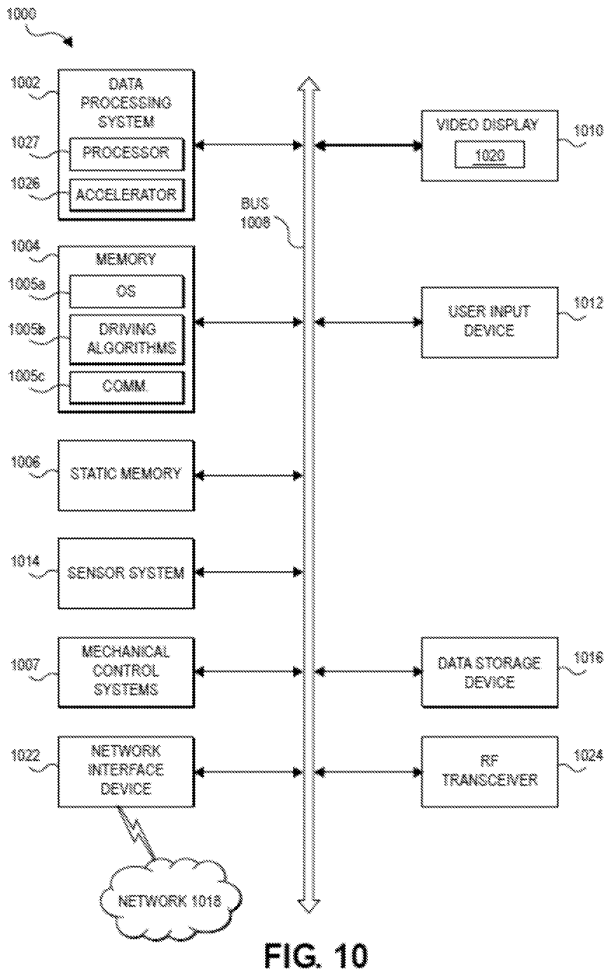

FIG. 10 is a block diagram of a vehicle 1000 according to embodiments herein. Within the processing system 1002 (or computer system 1002) is a set of instructions for causing the machine to perform any one or more of the methodologies discussed herein including machine learning operations for object detection and part segmentation. In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The processing system 1002, as disclosed above, includes processing logic in the form of a general purpose instruction-based processor 1027 or an accelerator 1026 (e.g., graphics processing units (GPUs), FPGA, ASIC, etc.)). The general purpose instruction-based processor may be one or more general purpose instruction-based processors or processing devices (e.g., microprocessor, central processing unit, or the like). More particularly, processing system 1002 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like.

Processing system 1002 is configured to perform the operations and methods discussed herein. The example vehicle 1000 includes a processing system 1002, main memory 1004 (e.g., read-only memory (ROM), flash memory, dynamic random access memory (DRAM) such as synchronous DRAM (SDRAM) or DRAM (RDRAM), etc.), a static memory 1006 (e.g., flash memory, static random access memory (SRAM), etc.), and a data storage device 1016 (e.g., a secondary memory unit in the form of a drive unit, which may include fixed or removable computer-readable storage medium), which communicate with each other via a bus 1008. The storage units disclosed herein may be configured to implement the data storing mechanisms for performing the operations and methods discussed herein. Memory 1006 can store code and/or data for use by processor 1027 or accelerator 1026. Memory 1006 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1027 and accelerator 1026 execute various software components stored in memory 1004 to perform various functions for system 1002. Furthermore, memory 1006 may store additional modules and data structures not described above.

Operating system 1005a includes various procedures, sets of instructions, software components and/or drivers for controlling and managing general system tasks and facilitates communication between various hardware and software components. Driving algorithms 1005b (e.g., method, object detection, driver assistance, etc.) utilize sensor data from the sensor system 1014 to provide object detection, segmentation, driver assistance features, and tire road friction limit nearness estimation for different applications such as driving operations of vehicles. A communication module 1005c provides communication with other devices utilizing the network interface device 1022 or RF transceiver 1024.

The vehicle 1000 may further include a network interface device 1022. In an alternative embodiment, the data processing system disclosed is integrated into the network interface device 1022 as disclosed herein. The vehicle 1000 also may include a video display unit 1010 (e.g., a liquid crystal display (LCD), LED, or a cathode ray tube (CRT)) connected to the computer system through a graphics port and graphics chipset, an input device 1012 (e.g., a keyboard, a mouse), and a Graphic User Interface (GUI) 1020 (e.g., a touch-screen with input & output functionality) that is provided by the display 1010.

The vehicle 1000 may further include a RF transceiver 1024 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The data storage device 1016 may include a machine-readable storage medium (or more specifically a computer-readable storage medium) on which is stored one or more sets of instructions embodying any one or more of the methodologies or functions described herein.

Disclosed data storing mechanism may be implemented, completely or at least partially, within the main memory 1004 and/or within the data processing system 1002, the main memory 1004 and the data processing system 1002 also constituting machine-readable storage media.

In one example, the vehicle 1000 with driver assistance is an autonomous vehicle that may be connected (e.g., networked) to other machines or other autonomous vehicles using a network 1018 (e.g., LAN, WAN, cellular network, or any network). The vehicle can be a distributed system that includes many computers networked within the vehicle. The vehicle can transmit communications (e.g., across the Internet, any wireless communication) to indicate current conditions (e.g., an alarm collision condition indicates close proximity to another vehicle or object, a collision condition indicates that a collision has occurred with another vehicle or object, etc.). The vehicle can operate in the capacity of a server or a client in a client-server network environment, or as a peer machine in a peer-to-peer (or distributed) network environment. The storage units disclosed in vehicle 1000 may be configured to implement data storing mechanisms for performing the operations of autonomous vehicles.

The vehicle 1000 also includes sensor system 1014 and mechanical control systems 1007 (e.g., chassis control, vehicle propulsion system, driving wheel control, brake control, etc.). The system 1002 executes software instructions to perform different features and functionality (e.g., driving decisions) and provide a graphical user interface 1020 for an occupant of the vehicle. The system 1002 performs the different features and functionality for autonomous operation of the vehicle based at least partially on receiving input from the sensor system 1014 that includes lidar sensors, cameras, radar, GPS, and additional sensors. The system 1002 may be an electronic control unit for the vehicle.

The above description of illustrated implementations of the embodiments herein, including what is described in the Abstract, is not intended to be exhaustive or to limit the embodiments herein to the precise forms disclosed. While specific implementations of, and examples for, the embodiments are described herein for illustrative purposes, various equivalent modifications are possible within the scope of the embodiments herein, as those skilled in the relevant art will recognize.

These modifications may be made to the embodiments herein in light of the above detailed description. The terms used in the following claims should not be construed to limit the embodiments to the specific implementations disclosed in the specification and the claims. Rather, the scope of the embodiments is to be determined entirely by the following claims, which are to be construed in accordance with established doctrines of claim interpretation.

1. A method comprising:
receiving, by a processing device implementing a mission manager in an autonomous vehicle (AV), a mission from an input source of the AV, the mission comprising a request for a task that the AV is to fulfill;
deconflicting the mission with one or more other missions of the AV to generate a ranked list of missions;
selecting a target mission from the ranked list of missions in accordance with priorities corresponding to each mission in the ranked list of missions;
generating one or more scenarios based on the target mission, the one or more scenarios comprising encoded representations of local and geometric terms to cause the target mission to be fulfilled by the AV; and
dispatching the one or more scenarios to a planner layer of the AV.

2. The method of claim 1, wherein the input source comprises at least one of a customer to send an input address, a fleet management source to send an instruction, AV override sources, or remote assistance (RA) to send a remote assistance request.

3. The method of claim 1, wherein generating one or more scenarios further comprises:
identifying, based on a scenario library maintained by the mission manager, parameters of behaviors of the AV to at least partially satisfy the mission; and
encoding the parameters in a representation of the one or more scenarios as a scenario application programming interface (API) message.

4. The method of claim 3, wherein the parameters comprise at least one of a priority, a goal, or a trajectory policy, wherein the goal comprises an end state of the AV and constraints that apply to the end state, and wherein the trajectory policy comprises at least one of an urgency or a behavioral flag.

5. The method of claim 4, wherein the goal comprises a stop goal or a go goal, and wherein the constraints that apply to the end state comprise at least one of an inclusion region, an exclusion region, a position, or a heading angle.

6. The method of claim 3, wherein the scenario API message is encoded in Robot Operating System (ROS) message format.

7. The method of claim 1, wherein a scenario evaluation is generated by the planner layer and comprises feedback that identifies an outcome of a solving and a costing of the one or more scenarios by the planner layer.

8. The method of claim 7, wherein the outcome comprises at least one of satisfied, planned, infeasible, unattempted, or unsupported.

9. The method of claim 1, wherein the mission is received at the mission manager using a missions API implemented in the AV, and wherein the one or more scenarios are dispatched using a scenarios API implemented in the AV.

10. The method of claim 1, further comprising:
generating, by the planner layer, a set of possible trajectory solutions from the one or more scenarios; and
executing, by a control system, a concrete series of poses from a selected trajectory solution of the set of possible trajectory solutions.

11. The method of claim 10, further comprising costing, by the planner layer, the set of possible trajectory solutions and selecting the selected trajectory solution based on the costing of the set of possible trajectory solutions.

12. An apparatus comprising:
at least one memory; and
at least one processor coupled to the at least one memory, wherein the at least one processor is to:
receive, at a mission manager implemented by the at least one processor of an autonomous vehicle (AV), a mission from an input source of the AV, the mission comprising a request for a task that the AV is to fulfill;
deconflict the mission with one or more other missions of the AV to generate a ranked list of missions;
select a target mission from the ranked list of missions in accordance with priorities corresponding to each mission in the ranked list of missions;
generate one or more scenarios based on the target mission, the one or more scenarios comprising encoded representations of local and geometric terms to cause the target mission to be fulfilled by the AV; and
dispatch the one or more scenarios to a planner layer of the AV.

13. The apparatus of claim 12, wherein generating one or more scenarios further comprises the at least one processor to:
identify, based on a scenario library maintained by the mission manager, parameters of behaviors of the AV to at least partially satisfy the mission; and
encode the parameters in a representation of the one or more scenarios as a scenario application programming interface (API) message.

14. The apparatus of claim 13, wherein the parameters comprise at least one of a priority, a goal, or a trajectory policy, wherein the goal comprises a stop goal or a go goal that define an end state of the AV and comprises constraints that apply to the end state, and wherein the trajectory policy comprises at least one of an urgency or a behavioral flag.

15. The apparatus of claim 12, wherein the mission is received at the mission manager using a missions API implemented in the AV, and wherein the one or more scenarios are dispatched using a scenarios API implemented in the AV.

16. The apparatus of claim 12, the at least one processor is further to:
generate, by the planner layer, a set of possible trajectory solutions from the one or more scenarios;
cost, by the planner layer, the set of possible trajectory solutions and select a selected trajectory solution based on the costing of the set of possible trajectory solutions; and
execute, by a control system, a concrete series of poses from the selected trajectory solution.

17. A non-transitory computer-readable medium having stored thereon instructions that, when executed by one or more processors, cause the one or more processors to:
receive, at a mission manager implemented by the one or more processors of an autonomous vehicle (AV), a mission from an input source of the AV, the mission comprising a request for a task that the AV is to fulfill;
deconflict the mission with one or more other missions of the AV to generate a ranked list of missions;
select a target mission from the ranked list of missions in accordance with priorities corresponding to each mission in the ranked list of missions;
generate one or more scenarios based on the target mission, the one or more scenarios comprising encoded representations of local and geometric terms to cause the target mission to be fulfilled by the AV; and
dispatch the one or more scenarios to a planner layer of the AV.

18. The non-transitory computer-readable medium of claim 17, wherein the one or more processors to generate one or more scenarios further comprises the one or more processors to:
identify, based on a scenario library maintained by mission manager, parameters of behaviors of the AV to at least partially satisfy the mission; and
encode the parameters in a representation of the one or more scenarios as a scenario application programming interface (API) message.

19. The non-transitory computer-readable medium of claim 18, wherein the parameters comprise at least one of a priority, a goal, or a trajectory policy, wherein the goal comprises a stop goal or a go goal that define an end state of the AV and comprises constraints that apply to the end state, and wherein the trajectory policy comprises at least one of an urgency or a behavioral flag.

20. The non-transitory computer-readable medium of claim 17, wherein the instructions are further to cause the one or more processors to:
generate, by the planner layer, a set of possible trajectory solutions from the one or more scenarios;
cost, by the planner layer, the set of possible trajectory solutions and selecting a selected trajectory solution based on the costing of the set of possible trajectory solutions; and
execute, by a control system, a concrete series of poses from the selected trajectory solution.
